(19) United States
(12) Patent Application Publication
(10) Pub. No.: US 2022/0333797 A1
(43) Pub. Date: Oct. 20, 2022

(54) SYSTEM FOR CREATING A MICROENVIRONMENT WITHIN AN AMBIENT ENVIRONMENT

(71) Applicant: FLOWGenuity Inc., Toronto (CA)

(72) Inventors: Jay Levine, Toronto (CA); Karen Basian, Toronto (CA); Kevin Belusa, Mississauga (CA)

(21) Appl. No.: 17/723,694

(22) Filed: Apr. 19, 2022

Related U.S. Application Data
(60) Provisional application No. 63/177,013, filed on Apr. 20, 2021.

(51) Int. Cl. F24F 3/167; F24F 8/30

(52) U.S. Cl. CPC F24F 3/167; F24F 8/30; F24F 2009/007

(57) ABSTRACT

A system and method for creating a microenvironment within an ambient environment is disclosed. The first outlet is configured for expelling a gas at a first velocity sufficient for producing a gas curtain that separates the microenvironment from the ambient environment. The second outlet is configured for expelling the gas at a second velocity within the microenvironment. An inlet is spaced apart from the first outlet and the second outlet and is in fluid communication with a suction unit. The suction unit is positioned downstream of the inlet and configured for removing gas from the microenvironment through the inlet. The first velocity is greater than the second velocity.

### CROSS-REFERENCE TO RELATED APPLICATIONS

This application claims benefit of the filing date of U.S. Provisional Patent Application No. 63/177,013 filed on Apr. 20, 2021, the contents of which are incorporated herein by reference.

### FIELD

This application relates to the field of creating a microenvironment within an ambient environment, and more particularly, separating the microenvironment from the ambient environment by a gas curtain.

### INTRODUCTION

The following is not an admission that anything discussed below is part of the prior art or part of the common general knowledge of a person skilled in the art.

Various types of air curtains are known, including barriers that are formed of two parallel physical walls and two parallel air curtains for separating one environment from another.

### SUMMARY

In accordance with one aspect of this disclosure, a system for creating a microenvironment within an ambient environment is provided with a gas source and first and second outlets. The first outlet is configured for expelling a gas for producing a gas curtain and the second outlet is configured for expelling gas within the microenvironment. An advantage of this design is that the microenvironment can be separated from the ambient environment while also providing gas flow within the microenvironment such that the microenvironment can have conditions that are independent of the ambient environment.

In accordance with this aspect, there is provided a system for using a gas to create a microenvironment within an ambient environment, the system comprising:

a first outlet configured for expelling a gas at a first velocity sufficient for producing a gas curtain, wherein the gas curtain separates the microenvironment from the ambient environment;

a second outlet configured for expelling the gas at a second velocity within the microenvironment, wherein the first velocity is greater than the second velocity;

an inlet spaced apart from the first outlet and the second outlet;

a suction unit in fluid communication with the inlet and the first and second outlets, the suction unit located downstream of the inlet and upstream of the first and second outlets, wherein the suction unit is configured for removing the gas from the microenvironment through the inlet and supplying at least a portion of the gas expelled from the first and second outlets.

In any embodiment, the suction unit may be configured to supply all of the gas expelled by the first and second outlets.

In any embodiment, the system may further comprise a gas source configured to deliver a remaining portion of the gas expelled by the first and second outlets from an external environment.

In any embodiment, the inlet may be located below the first outlet and the second outlet.

In any embodiment, the system may further comprise a treatment unit upstream of the first and second outlets.

In any embodiment, the treatment unit may comprise at least one of an ionizer and an air filter.

In any embodiment, the suction unit may be configured to recirculate the gas removed through the inlet to the first and second outlets.

In any embodiment, the system may be configured such that the direction of the gas entering the inlet is substantially perpendicular to the direction of the gas expelled by the first outlet and the second outlet.

In any embodiment, the inlet may comprise a first inlet and a second inlet, the second inlet being positioned between the first inlet and the first outlet, wherein the gas in the microenvironment is removed through the second inlet.

In any embodiment, the first outlet may be a slot that has a thickness, the thickness may be in the range of about 12 mm to about 100 mm.

In any embodiment, the system may further comprise a blower for increasing at least one of the first velocity and the second velocity.

In any embodiment, the first outlet may surround at least three sides of the second outlet.

In any embodiment, the first velocity may be in the range of about 1 m/s to about 3 m/s.

In any embodiment, the second velocity may be in the range of about 0.3 m/s to about 1 m/s.

In any embodiment, the microenvironment may define a volume of gas and the system may be configured to exchange the volume of gas at a rate of at least about 20 gas changes per hour.

In accordance with another aspect of this disclosure, there is provided a system for using a gas to create a microenvironment within an ambient environment, the system comprising:

a gas source;

a first outlet located downstream of the gas source and in fluid communication with the gas source, wherein the gas is expelled from the first outlet at a first velocity sufficient for producing a gas curtain, wherein the gas curtain separates the microenvironment from the ambient environment;

a second outlet located downstream of the gas source and in fluid communication with the gas source, wherein the gas is expelled from the second outlet into the microenvironment at a second velocity, wherein the first velocity is greater than the second velocity;

an inlet spaced apart from the first outlet and the second outlet;

a suction unit in fluid communication with the inlet, the suction unit located downstream of the inlet, wherein the suction unit is configured for removing the gas from the microenvironment through the inlet.

In accordance with another aspect of the disclosure, there is provided a method of using a gas to create a microenvironment within an ambient environment, the method comprising:

providing a gas curtain, wherein the gas curtain is provided by the gas expelled from a first outlet at a first velocity, wherein the gas curtain separates the microenvironment from the ambient environment;

providing an interior gas flow within the microenvironment, wherein the interior gas flow is provided by the gas expelled from a second outlet into the microenvironment at a second velocity, wherein the first velocity is greater than the second velocity; and

removing the gas from the microenvironment through an inlet in fluid communication with a suction unit, wherein the suction unit is configured to supply at least a portion of the gas expelled from the first and second outlets.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1A is a front perspective view of a system in accordance with an embodiment;

FIG. 1B is a rear perspective view of the system of FIG. 1A;

FIG. 2A is a top view of the system of FIG. 1A;

FIG. 2B is a rear view of the system of FIG. 1A;

FIG. 2C is a front view of the system of FIG. 1A;

FIG. 2D is a side view of the system of FIG. 1A;

FIG. 3 is a front perspective cross-sectional view along line 3-3 in FIG. 2B;

FIG. 4 is a side cross-sectional view along line 3-3 in FIG. 2B;

FIG. 5 is an exploded view of the system of FIG. 1A;

FIG. 6 is another exploded view of the system of FIG. 1A;

FIG. 7A is a front perspective view of the system of FIG. 1A with a gas curtain in operation;

FIG. 7B is a front perspective view of the system of FIG. 1A with an interior gas flow in operation;

FIG. 7C is a front perspective view of the system of FIG. 1A with the gas curtain and interior gas flow in operation;

FIG. 8A is a front perspective view of the system of FIG. 1A in another mode of operation;

FIG. 8B is a rear perspective view of the system of FIG. 1A in the mode of operation of FIG. 8A;

FIG. 9A is a front perspective view of the system of FIG. 1A located in an enclosed space;

FIG. 9B is a top view of the system of FIG. 1A in an enclosed space;

FIG. 10A is a front perspective view of the enclosed space of FIG. 9A with the system in another position;

FIG. 10B is a front perspective view of the enclosed space of FIG. 9A with the system in another position;

FIG. 11 is a front perspective view of another exemplary system;

FIG. 12 is a front perspective view of a simulation with another exemplary system in an enclosed space;

FIG. 13A is a front view of a computational fluid dynamic velocity diagram of a simulated use of the system of FIG. 11 in the simulation of FIG. 12;

FIG. 13B is a front view of a computational fluid dynamic temperature diagram of a simulated use of the system of FIG. 11 in the simulation of FIG. 12;

FIG. 14A is a side view of a computational fluid dynamic velocity diagram of a simulated use of the system of FIG. 11 in the simulation of FIG. 12;

FIG. 14B is a side view of a computational fluid dynamic temperature diagram of a simulated use of the system of FIG. 11 in the simulation of FIG. 12;

FIG. 15A is a front view of a computational fluid dynamic velocity diagram illustrating a scalar mass exhaled by a patient in the system of FIG. 11 in the simulation of FIG. 12;

FIG. 15B is a side view of a computational fluid dynamic velocity diagram illustrating a scalar mass exhaled by a patient in the system of FIG. 11 in the simulation of FIG. 12;

FIG. 16A is a front view of a computational fluid dynamic velocity diagram illustrating a scalar mass exhaled by a health worker in the system of FIG. 11 in the simulation of FIG. 12;

FIG. 16B is a front view of a computational fluid dynamic velocity diagram illustrating a scalar mass exhaled by an assistant in the system of FIG. 11 in the simulation of FIG. 12;

FIG. 17 is a front perspective view of a computational fluid dynamic velocity diagram illustrating streamlines of the exhalation of the patient in FIG. 15A.

FIG. 18 is a front perspective view of a computational fluid dynamic velocity diagram illustrating streamlines of the exhalation of the assistant in FIG. 16B.

FIG. 19 is a front perspective view of a computational fluid dynamic velocity diagram illustrating streamlines of the exhalation of the health worker in FIG. 16A.

FIG. 20 is a front perspective view of a computational fluid dynamic velocity diagram illustrating streamlines of the gas curtain of the system of FIG. 11 in the simulation of FIG. 12 when the gas curtain is penetrated by the health worker;

FIG. 21 is a front perspective view of a computational fluid dynamic velocity diagram illustrating streamlines of the interior gas flow of the system of FIG. 11 in the simulation of FIG. 12 when the gas curtain is penetrated by the physician;

FIG. 22 is an illustration of another exemplary system in use by a health worker;

FIG. 23A is a front perspective view of a system in accordance with another embodiment;

FIG. 23B is a front perspective view of the system of FIG. 23A with a front panel removed;

FIG. 23C is a rear perspective view of the system of FIG. 23A;

FIG. 24 is an exploded view of the system of FIG. 23A;

FIG. 25A is a cross-sectional view of a hood of the system of FIG. 23A, along line 25-25 in FIG. 23A;

FIG. 25B is a cross-sectional perspective view of the hood of the system of FIG. 23A, along line 25-25 in FIG. 23A;

FIG. 26A is a cross-sectional front perspective view of the hood of the system of FIG. 23A, along line 26-26 in FIG. 23A;

FIG. 26B is a cross-sectional side view of the system of FIG. 23A with a side panel removed, along line 26-26 in FIG. 23A;

FIG. 27A is a cross-sectional perspective view of the hood of the system of FIG. 23A, along lines 25-25 in FIG. 23A and 27-27 in FIG. 25A;

FIG. 27B is a cross-sectional perspective view of the hood of the system of FIG. 23A, along lines 25-25 in FIG. 23A and 27-27 in FIG. 25A;

FIG. 27C is a schematic view of gas flow in the hood of the system of FIG. 23A;

FIG. 28A is a cross-sectional front perspective view of the system of FIG. 23A with the front panel removed, along line 28A-28A in FIG. 23A;

FIG. 28B is a cross-sectional perspective view of the system of FIG. 23A with the front panel removed, along line 28B-28B in FIG. 23B and line 28C-28C in FIG. 23B;

FIG. 28C is a schematic view of gas flow in the system of FIG. 23A; and

FIG. 29 is a schematic side view of gas flow in the system of FIG. 23A.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method, or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

As used herein, the wording “and/or” is intended to represent an inclusive - or. That is, “X and/or Y” is intended to mean X or Y or both, for example. As a further example, “X, Y, and/or Z” is intended to mean X or Y or Z or any combination thereof.

As used herein and in the claims, two elements are said to be “parallel” where those elements are parallel and spaced apart, or where those elements are collinear.

A System for Separating a Microenvironment from an Ambient Environment

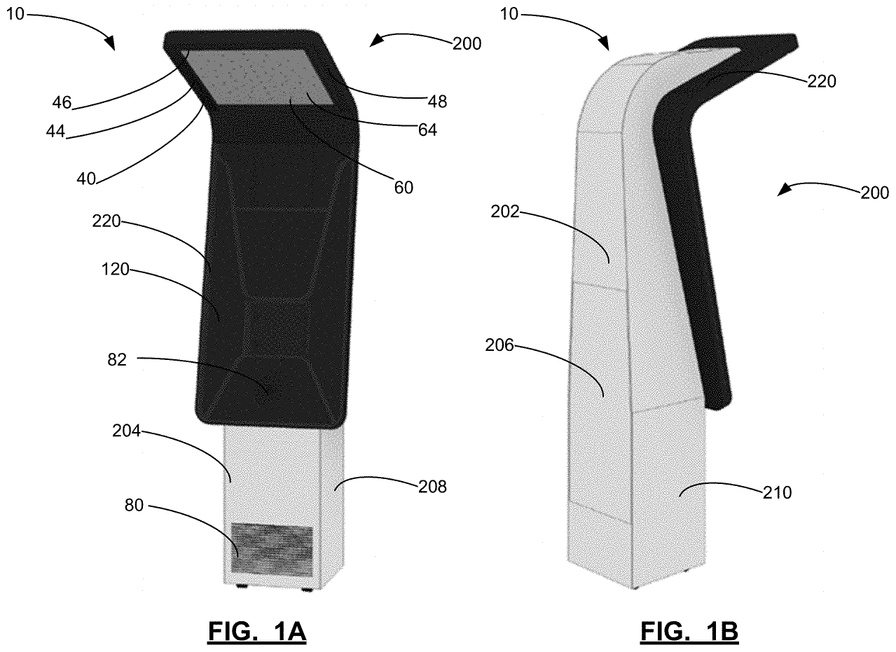

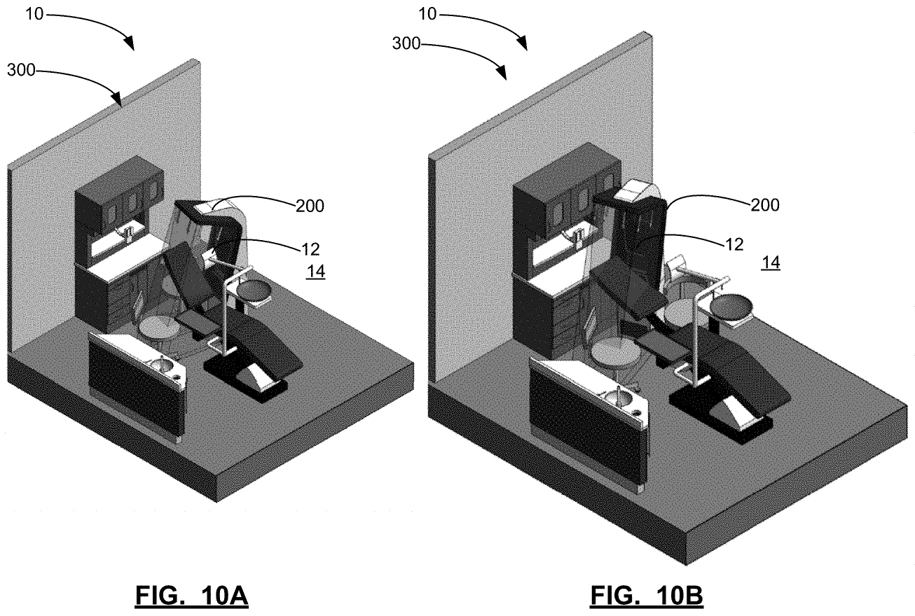

Referring to FIGS. 1-10, an exemplary embodiment of a system for separating a microenvironment from an ambient environment is shown generally as 10. The following is a general discussion of system 10, which provides a basis for understanding several of the features that are discussed herein. As discussed subsequently, each of the features may be used individually or in any particular combination or sub-combination in this or in other embodiments disclosed herein.

Referring to FIGS. 1-10, shown therein is an exemplary embodiment of a system 10 for creating a microenvironment 12 within an ambient environment 14. As used herein, the term microenvironment means a volume of space within the ambient environment that is capable of having different environmental conditions than the ambient environment 14. The microenvironment 12 may be treated independently from the ambient environment 14 to vary the microenvironment conditions. For example, gas within the microenvironment 12 may be treated to vary the temperature, humidity, scent, oxygen levels, level of contamination, or any other form of treatment. An advantage of this design is that the microenvironment 21 can be separated from the ambient environment 14 while also providing gas flow within the microenvironment 12 such that the microenvironment 12 can be conditioned independently of the ambient environment 14.

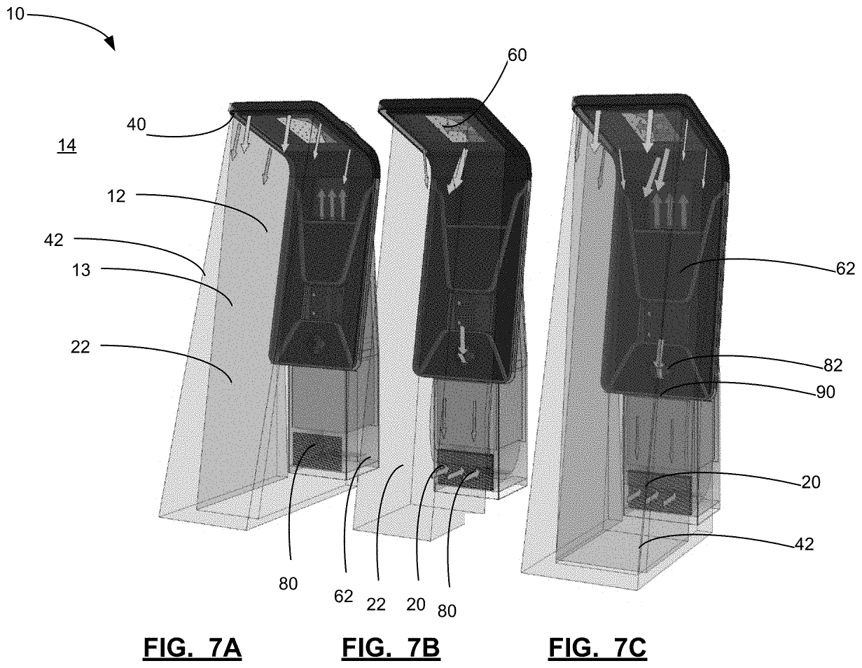

Referring now to FIGS. 7A-7C, the system 10 includes a gas source 20 for supplying gas 22 to a first outlet 40 in fluid communication with the gas source 20 and a second outlet 60 in fluid communication with the gas source 20. The first outlet 40 is configured for expelling the gas 22 at a first velocity sufficient for producing an exterior gas flow 42, also referred to as the gas curtain 42. The second outlet 60 is configured for expelling the gas 22 at a second velocity within the microenvironment 12. The gas 22 expelled by the second outlet 60 may also be referred to as the interior gas flow 62. In the exemplary embodiments described herein, the gas is air, but those skilled in the art will appreciate that any other suitable gas or combination of gases may be used.

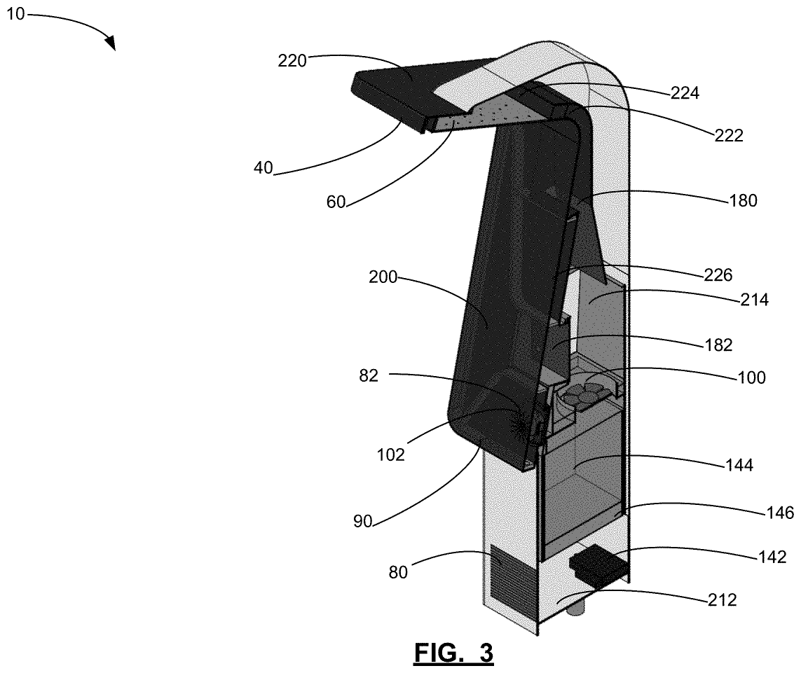

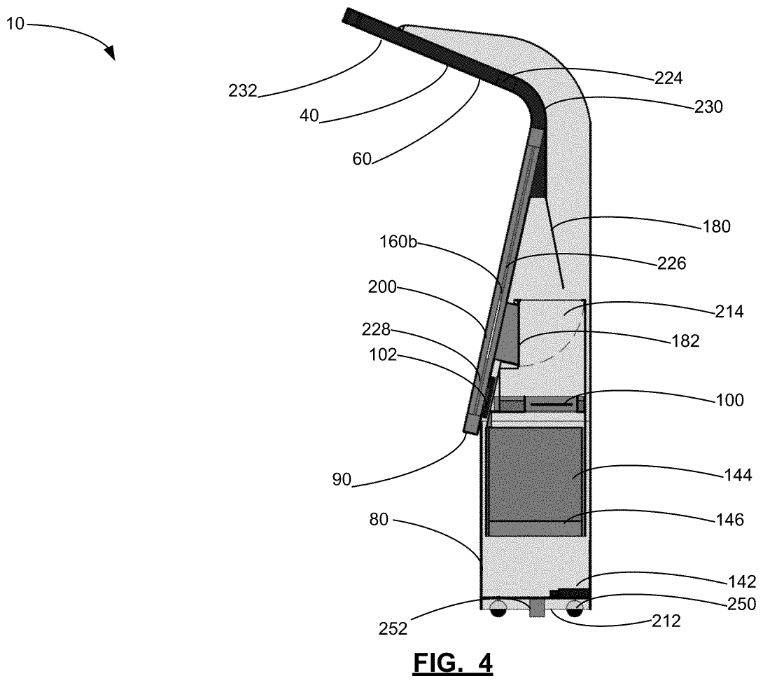

Referring now to FIGS. 3 and 4, the system 10 also includes an inlet 80 spaced apart from the first outlet 40 and the second outlet 60. The inlet 80 is in fluid communication with a suction unit 100. The suction unit 100 is configured for removing gas 22 from the microenvironment 12 through the inlet 80. In the exemplary embodiment of FIGS. 1-10, the suction unit 100 operates to provide the gas source 20 to the first outlet 40 and the second outlet 60 by supplying the gas 22 removed from the microenvironment 12 to the first outlet 40 and the second outlet 60. Accordingly, the gas 22 from the microenvironment 12 is recirculated through the system 10 and the suction unit 100 is configured to supply all of the gas 22 expelled by the first outlet 40 and the second outlet 60. In some embodiments, the suction unit 100 may supply a portion of the gas 22 expelled from the first outlet 40 and the second outlet 60. In other embodiments, the suction unit 100 may not supply any gas 22 to the first outlet 40 and the second outlet 60 and may remove the gas 22 from the microenvironment 12 to another location external to the ambient environment 14.

In operation, the gas curtain 42 separates the microenvironment 12 from the ambient environment 14 while the interior gas flow 62 is expelled from the second outlet 60 towards the inlet 80. The suction unit 100 creates a pressure differential that causes the gas 22 to be removed from the microenvironment 12 through the inlet 80. Accordingly, the microenvironment 12 is formed and is capable of having different environmental characteristics from the ambient environment 14. In some embodiments, the microenvironment 12 may be treated to remove contaminants from within the microenvironment 12 such that the contaminants are substantially prevented from entering the ambient environment 14. For example, contaminants generated within the microenvironment 12 may be removed through the inlet 80 and disposed of to an external environment and/or treated to filter the contaminants from the gas 22 such that the gas 22 can be safely recirculated through the system 10.

It will be appreciated that the system 10 may be built into an existing or new HVAC system or may be a discrete system. For example, referring to FIGS. 1-10, the system 10 is a discrete apparatus 200 with a hood 220 for isolating a single person within the microenvironment 12 from the ambient environment 14. In some embodiments, the size of the system 10 may be large enough to contain a plurality of people within the microenvironment 12. In some embodiments, the discrete apparatus may be movable.

It will also be appreciated that the system 10 may be used in any ambient environment 14 such as, including, but not limited to hallways, waiting rooms, operatories, satellite operating rooms, elevators, classrooms, wards, meeting rooms, theatres, assembly rooms, lobbies, dining areas, washroom facilities, dressing rooms, team benches, field hospitals, laboratories, manufacturing facilities, residential rooms, and/or offices.

Gas Curtain and Interior gas flow

In accordance with this aspect, which may be used by itself or in combination with one or more other aspects, the gas curtain 42 and the interior gas flow 62 operate with dynamic gas flows. An advantage of this design is that the gas curtain 42 and interior gas flow 62 operate dynamically to separate the microenvironment 12 from the ambient environment 14 while also facilitating the gas flow within the microenvironment 12 towards the inlet 80. In other words, the flow of the gas curtain 42 and interior gas flow 62 cooperate to facilitate movement of gas 22 from the first outlet 40 and the second outlet 60 towards the inlet 80.

As used herein, the term dynamic means that there is fluid exchange between the gas curtain 42 and the interior gas flow 62. For example, an inner wall of the gas curtain 42 facilitates the generally unidirectional gas flow of the interior gas flow 62, assisting with the movement of the gas 22 within the microenvironment 12 towards the inlet 80. As gas 22 is expelled from the second outlet 60, some gas 22 proximate the perimeter of the interior gas flow 62 may come into fluid contact with the gas curtain 42. The movement of the gas 22 within the gas curtain 42 may cause the peripheral gas 22 from the interior gas flow 62 to move in the same direction as the gas curtain 42. Accordingly, the gas curtain 42 and the interior gas flow 62 work together to move the gas 22 expelled from the first outlet 40 and the second outlet 60 in a generally unidirectional manner towards the inlet 80.

In accordance with this aspect, the velocity of the gas expelled from the first outlet 40 that forms the gas curtain 42 (this velocity is referred to as the “first velocity”) is greater than the velocity of the gas expelled from the second outlet 60 that forms the interior gas flow 62 (this velocity is referred to as the “second velocity”). Unless noted otherwise, the first and second velocities are in reference to the gas 22 as it is expelled from the first outlet 40 and the second outlet 60 respectively. It will be appreciated that the velocity of the gas 22 will vary once it moves away from the first outlet 40 and the second outlet 60. The relative velocities of the gas curtain 42 and the interior gas flow 62 allow the microenvironment 12 to be formed within the ambient environment 14 while also allowing the conditions within the microenvironment 12 to be varied. In other words, the higher first velocity of the gas curtain 42 forms a gas barrier that at least partially encloses the interior gas flow 62 within the microenvironment 12 to separate the microenvironment 12 from the ambient environment 14 and to substantially prevent diffusion of gas 22, and any vapours, particles, or contaminants, from the interior gas flow 62 from the microenvironment 12 into the ambient environment 14.

For example, the first velocity of the gas curtain 42 may be in the range of about 1 m/s to about 3 m/s when expelled from the first outlet 40 while the second velocity of the interior gas flow 62 may be in the range of about 0.3 m/s to about 1 m/s when expelled from the second outlet 60.

It will be appreciated that the velocities of the gas curtain 42 and the interior gas flow 62 may vary depending on the desired use of the system 10. For example, if the first outlet 40 is positioned in the ceiling of an enclosed space, such as a room, the first velocity may be varied to achieve a particular velocity by the time the gas 22 has travelled a certain distance, such as the distance between the first outlet 40 and a head of a person in the room. In other words, the first velocity of the gas curtain 42 may be chosen so that the velocity has a particular value at a particular location within the enclosed space. For example, the first velocity may be 2 m/s as it is expelled from the first outlet 40 and may decrease to 1 m/s by the time the gas 22 in the gas curtain 42 reaches a person within the microenvironment 12.

As described above, the interior gas flow 62 moves gas 22 from the second outlet 60 to the inlet 80. When aerosols or other contaminants are generated in the microenvironment 12, e.g., by a person breathing while in the microenvironment 12, the interior gas flow 62 operates to flush these contaminants unidirectionally towards the inlet 80. Accordingly, the contaminants may then be removed through the inlet 80 by the suction unit 100.

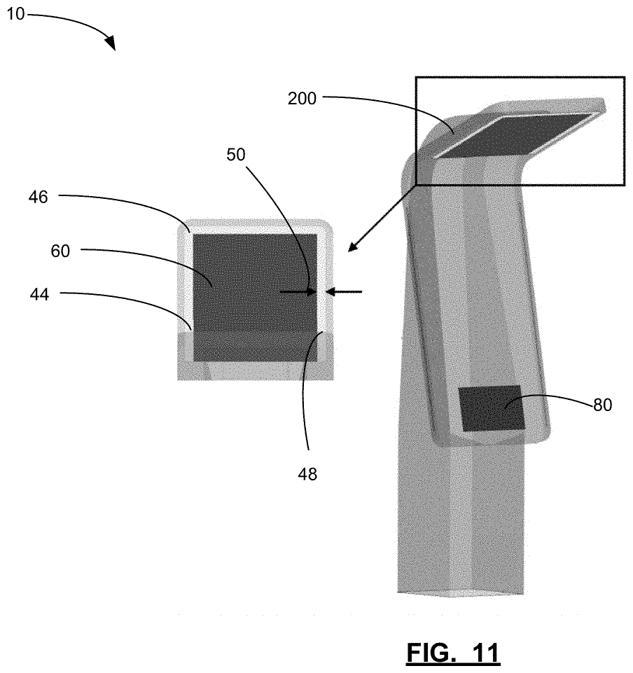

It will be appreciated that the first outlet 40 may have any suitable shape and/or size depending on the desired use of the system 10. As shown most clearly in FIGS. 7A-7C and 11, the first outlet 40 is U-shaped formed by a first slot 44, a second slot 46, and a third slot 48. As shown, this first outlet 40 configuration produces a gas curtain 42 in three different planes.

Referring again to FIGS. 7A-7C, there may be one physical wall 120 used to complete the separation of the microenvironment 12 from the ambient environment 14. In some embodiments, there may be a plurality of physical walls 120. For example, two physical walls 120 may form a corner while the gas curtain 42 forms two planes to complete the separation of the microenvironment 12 from the ambient environment. An exemplary embodiment of this system may be in an elevator. In such an embodiment, there may be a gas curtain 42 used in each corner of the elevator, separating four microenvironments 12 from the ambient environment 14. Each microenvironment 12 may be formed of its respective gas curtain 42 and one corner of the elevator. Accordingly, a person may be positioned within each microenvironment 12 such that each person is separated from the other occupants by their respective gas curtain 42. Additionally, the interior gas flow 62 in each microenvironment 12 may continuously operate to exchange the volume of gas 22 within each microenvironment 12. An advantage of this design is that, once a person has left the elevator, the gas 22 in the microenvironment 12 may be rapidly changed in time for a new person to enter the elevator and the microenvironment 12, thereby avoiding cross-contamination between occupants.

In some embodiments, the gas curtain 42 itself may entirely separate the microenvironment 12 from the ambient environment 14 without the use of physical walls 120. For example, the first outlet 40 may be annular, forming a cylindrical gas curtain 42. It will be appreciated that the gas curtain 42 may be any cross-sectional shape, including, but not limited to, square, rectangular, triangular, ellipsoid, or rhomboid.

As exemplified, the first outlet 40 is a continuous opening. In some embodiments, the first outlet 40 may be a plurality of openings. For example, the three slots 44, 46, and 48 may be separated from one another such that they are discrete openings. When in operation, the gas flows expelled from each opening may together form the gas curtain 42.

As illustrated in FIG. 1, the second outlet 60 may be formed of a plurality of openings 64. The plurality of openings 64 may be distributed throughout a cross-sectional plane of the interior gas flow 62 such that gas 22 expelled from the second outlet 60 is more evenly distributed throughout the microenvironment 12. The distribution of the plurality of openings 64 may improve the unidirectionality of the gas 22 expelled from the second outlet 60, thereby improving the consistency of gas movement within the microenvironment 12. In some embodiments, the second outlet 60 may be a single opening. In some embodiments, the second outlet 60 may include a wall outlet positioned proximate the one or more physical walls 120. The wall outlet may be used to provide additional gas flow along the physical walls 120 to assist with movement of gas flow within the microenvironment 12.

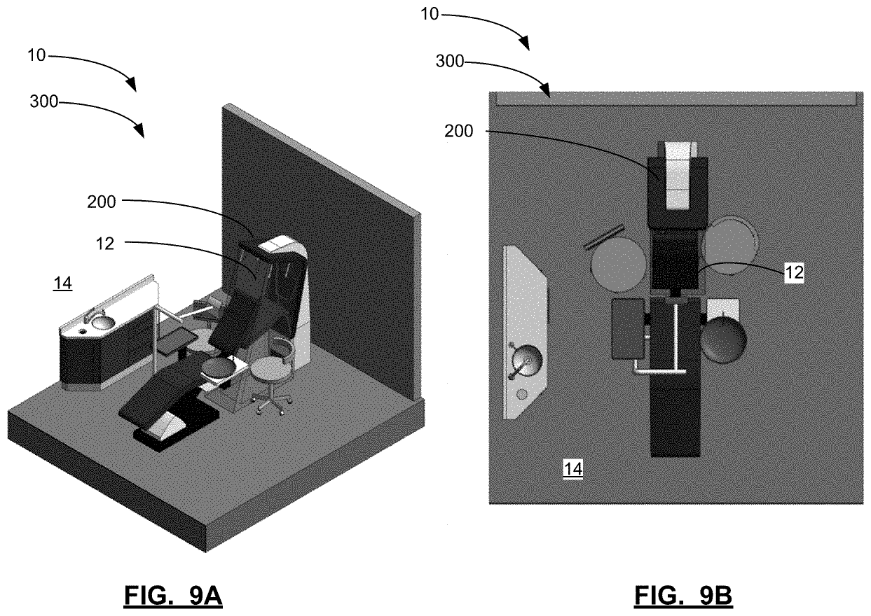

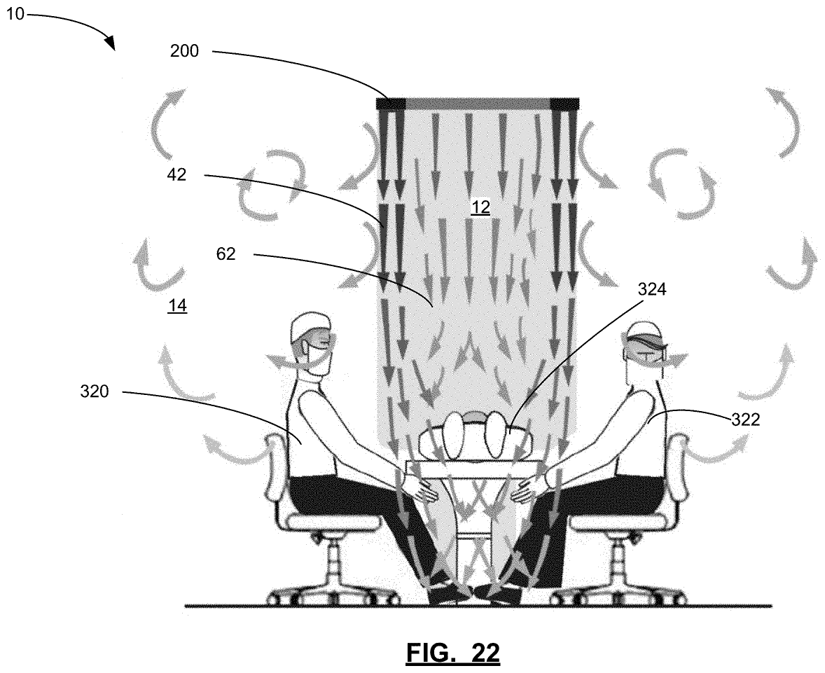

Referring now to FIG. 11, a thickness 50 of the first outlet 40 may be varied depending on the desired use of the system 10, resulting in a varied thickness of the gas curtain 42. For example, the thickness 50 may be in the range of about 12 mm to about 100 mm. The thickness 50 may depend on the distance between the first outlet 40 and the inlet 80. For example, if the distance between the first outlet 40 and the inlet 80 is large, a thicker gas curtain 42 may be used to improve the effectiveness of the gas curtain 42. The thickness 50 of the first outlet 40 may also depend on whether the gas curtain 42 will be penetrated by a person and/or object. For example, referring to FIGS. 9A-10B and 22, the system 10 may be used in health applications for separating a health worker, such as a dentist, hygienist, or doctor, from a patient. Accordingly, during use, the health worker will penetrate the gas curtain 42 in order to work on the patient. As exemplified, the thickness 50 of the first outlet 40 is 32 mm, which enables the health worker to penetrate the gas curtain 42 with the disruption of the health worker's arm releasing little to no gas 22 from within the microenvironment 12 to the ambient environment 14.

Alternately or in addition, the first velocity may be varied to improve the effectiveness of the gas curtain 42. Together, the thickness of the gas curtain 42 and the first velocity contribute to the flow rate of the gas curtain 42. Accordingly, the flow rate of the gas curtain 42 may be varied such that the gas curtain 42 substantially prevents diffusion of the interior gas flow 62 from the microenvironment 12 to the ambient environment 14. The flow rate of the gas curtain 42 may be varied as the distance between the first outlet 40 and the inlet 80 changes such that that the health worker can still penetrate the gas curtain 42 while releasing little to no gas 22 from within the microenvironment 12. In the event that some gas 22 is released from the microenvironment 12, e.g., due to the penetration of the gas curtain 42 by the health worker, the released gas 22 may still be returned to the system 10 through the inlet 80. It will be appreciated that other interruptions to the gas curtain 42 may result in an increased volume of gas 22 released from the microenvironment 12. However, the gas curtain 42 may still substantially prevent the gas 22 from leaving the microenvironment 12 despite the interruption of the gas curtain 42. Accordingly, the risk of gas 22 moving between the microenvironment 12 and the ambient environment 14 is substantially reduced.

As described above, the system 10 may be used to substantially prevent contaminants from moving from the microenvironment 12 to the ambient environment 14, and vice versa. Contaminated particles generated from the respiratory tract of a person have a wide size distribution, from 0.1-500 μm. The largest particles (>100 μm) fall out of the air rapidly onto surfaces. Intermediate sized particles (10-100 μm) can evaporate, reducing in size, and along with directly emitted smaller particles (<10 μm) can persist in the air from half an hour up to days, with the persistence time being inversely proportional to particle size. Accordingly, system 10 may be used to facilitate removal of these particles from the microenvironment 12. In operation, the interior gas flow 62 flushes small and intermediate-sized particles as they are generated by a person towards the inlet 80. The flow rate of the gas curtain 42 may be varied depending on the expected particle size of contaminants within the microenvironment 12. For example, at a gas curtain thickness 50 of 32 mm with a first velocity of 2 m/s, particles sized in the range of 0.1-100 μm may be substantially prevented from entering or leaving the microenvironment 12. It will be appreciated that the thickness 50 may be varied to address particles of varying sizes. As described above, an interruption of the gas curtain 42 may result in some gas 22 being released from the microenvironment 12 into the ambient environment 14. However, the risk of cross-contamination between the microenvironment 12 and the ambient environment 14 is substantially reduced by the presence of the gas curtain 42 and the interior gas flow 62.

It will be appreciated that the flow rate of the gas curtain 42 may also be varied such that the background conditions of the ambient environment 14 do not impact the operation of the system 10. For example, regardless of whether the ambient environment is positively pressurized, negatively pressurized, and/or has poor ventilation, the gas curtain 42 operates to separate the microenvironment 12 from the ambient environment 14 while substantially preventing gas 22 from leaving the microenvironment 12. Similarly, as described previously, the gas 22 within the microenvironment 12 may be treated by, for example, varying the temperature and/or humidity of the gas 22 in the microenvironment 12. Accordingly, the treatment characteristics of the gas 22 within the microenvironment 12 may also be maintained by preventing the gas 22 from leaving the microenvironment 12. In other words, if the gas 22 has been heated prior to entering the microenvironment 12, the heat retained by the gas 22 may be maintained as the gas 22 is recirculated through the microenvironment, without heat loss to the ambient environment 14. Conserving the treated gas 22 may improve the efficiency of the system 10, since less energy is required to maintain the gas 22 at a particular temperature and/or humidity.

### Inlet and Suction Unit

In accordance with this aspect, which may be used by itself or in combination with one or more other aspects, the suction unit 100 operates to remove gas 22 from the microenvironment 12. An advantage of this design is that the inlet 80 and suction unit 100 facilitate the generally unidirectional gas flow of gas 22 expelled from the first outlet 40 and the second outlet 60. Such unidirectional gas flow allows gas 22 to be removed from the microenvironment 12 to be recirculated through the system 10 or removed from the system 10.

In accordance with this aspect, as exemplified in FIGS. 1, the inlet 80 is spaced apart from the first outlet 40 and the second outlet 60. The inlet 80 is in fluid communication with the suction unit 100. Accordingly, gas 22 expelled from the first outlet 40 and the second outlet 60 is removed from the microenvironment 12 though the inlet 80 by the suction unit 100. According to the exemplary embodiment, the inlet 80 is located below the first outlet 40 and the second outlet 60. Positioning the inlet 80 below the first outlet 40 and the second outlet 60 may allow gravity to assist with the flow of gas 22 and/or contaminants towards the inlet 80 within the microenvironment 12. In some embodiments, the inlet 80 may be positioned above, beside, and/or at an angle to the first outlet 40 and the second outlet 60.

In some embodiments, as exemplified in FIGS. 1-10, the inlet 80 may be positioned within 30 cm from the floor of the space in which the system 10 is located. An advantage of this position is that a Coanda effect may be generated making use of the floor and/or wall where the inlet 80 is positioned, which may reduce the re-entrainment of gas 22 within the microenvironment 12.

As exemplified in FIGS. 7A-7C, the direction of gas entering the inlet 80 is substantially perpendicular to the gas 22 expelled from the first outlet 40 and the second outlet 60. However, it will be appreciated that the inlet 80 may be configured such that the gas entering it may be at any other suitable angle relative to the expelled gas 22. For example, the direction of the gas 22 entering the inlet 80 may be substantially parallel to the direction of expelled gas 22.

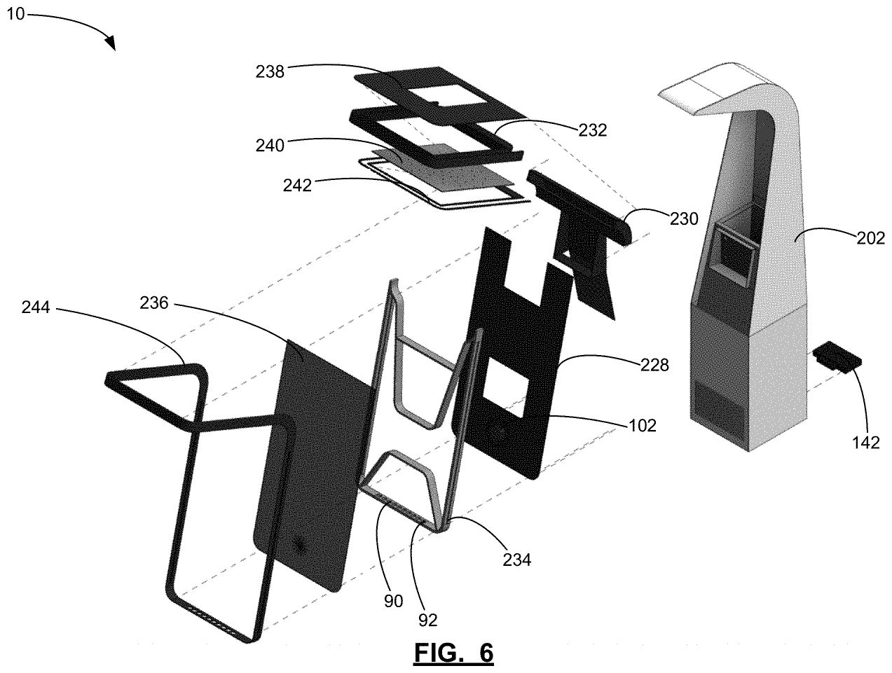

As exemplified in FIG. 3, the system 10 may also include an auxiliary inlet 82 and a second suction unit 102. As shown, the second suction unit 102 may be used for removing gas 22 from the microenvironment 12 through the auxiliary inlet 82. Once the gas 22 is removed through the auxiliary inlet 82, the second suction unit 102 expels the gas 22 through a third outlet 90, towards the inlet 80. The gas 22 is subsequently removed through the inlet 80, as described above. In other words, the auxiliary inlet 82 and the second suction unit 102 operate to move gas 22 more rapidly towards the inlet 80. As exemplified in FIG. 6, the third outlet 90 may include a plurality of openings 92. In some embodiments, the third outlet 90 may be a single opening.

The second suction unit 102 may be operated such that the gas 22 expelled from the third outlet 90 does not overpower the suction force at the inlet 80 provided by the suction unit 100. In other words, the velocity of the gas 22 expelled from the third outlet 90 is such that the suction force at the inlet 80 is sufficient to remove the gas 22 expelled from the third outlet 90 from the microenvironment 12.

It will be appreciated that the auxiliary inlet 82 may be positioned anywhere within the microenvironment 12. For example, in the exemplary embodiment of FIGS. 1-10, the system 10 is used to substantially prevent contaminants from entering the ambient environment 14. Accordingly, the auxiliary inlet 82 is positioned near a breathing zone when a patient is within the microenvironment 12. When the contaminants are airborne contaminants, the highest concentration of contaminants will be generated near the breathing zone of the patient. Positioning the auxiliary inlet 82 near the breathing zone may improve the efficiency of the system 10 in preventing the contaminants from entering the ambient environment 14 by more rapidly moving the contaminants towards the inlet 80 as they are generated. Accordingly, the contaminants have less time to be re-entrained in the gas 22 in the rest of the microenvironment 12 before they are removed by the inlet 80. As exemplified, the inlet 80 is positioned below the third outlet 90, which, as described previously, may assist with the removal of gas 22 from the microenvironment 12. In some embodiments, the inlet 80 may be positioned near the breathing zone of the patient, without the need of an auxiliary inlet 82.

In some embodiments, the system 10 may not have an auxiliary inlet 82. In some other embodiments, as shown in FIG. 11, the system may include a single inlet 80 (i.e., no auxiliary inlet) that is located higher from the floor than the inlet 80 illustrated in FIGS. 1-8.

It will be appreciated that the suction unit 100 may be any device capable of moving gas 22 from the microenvironment 12 through the inlet 80. As exemplified, the suction unit 100 is a fan that operates to blow gas 22, thereby creating a suction force at the inlet 80. Similarly, the second suction unit 102 may be any device capable of moving gas 22 through the auxiliary inlet 82 and expelling the gas 22 through the third outlet 90.

### Gas Source

In accordance with this aspect, which may be used by itself or in combination with one or more other aspects, the gas 22 from the gas source 20 may be treated upstream of the first outlet 40 and the second outlet 60. For example, the gas 22 may be filtered, ionized, humidified, dehumidified, heated, cooled, oxygenated, scented, decontaminated, scrubbed, cleaned and/or treated in any other manner. An advantage of this design is that the conditions of the microenvironment 12 may be varied independently from the conditions of the ambient environment 14. Additionally, when used for decontaminating the microenvironment 12, risk of contaminants moving to the ambient environment 14 may be reduced and/or eliminated. Similarly, if the conditions in the ambient environment are contaminated, the microenvironment 12 may be remediated by treating the gas 22 expelled by the first outlet 40 and the second outlet 60.

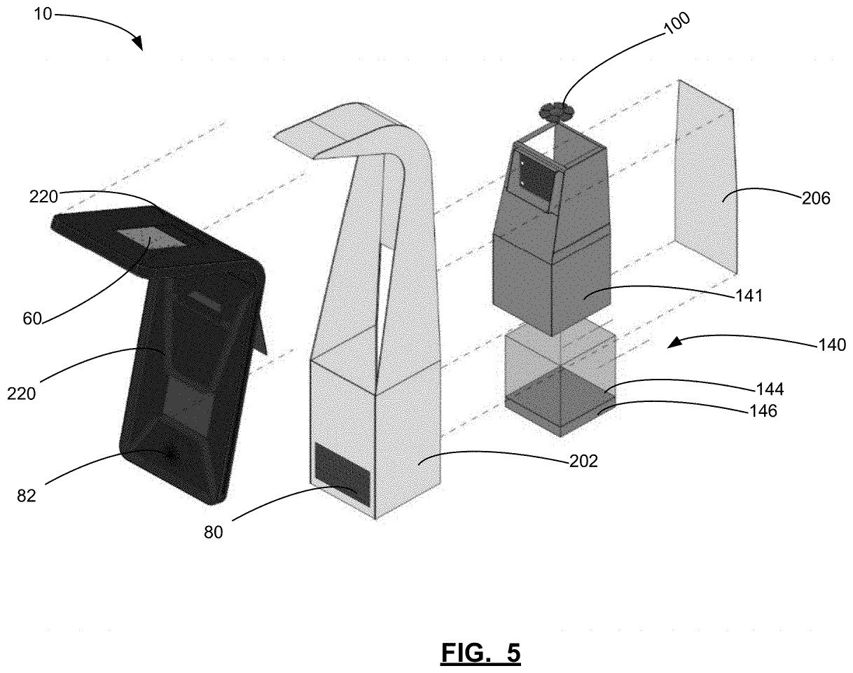

In accordance with this aspect, the system 10 includes a treatment unit 140. As described above, the treatment unit 140 may be used to treat the gas 22 upstream of the first outlet 40 and the second outlet 60. As exemplified in FIGS. 3 and 4, the treatment unit 140 includes an ionizer 142 and a filter 144. As exemplified in FIG. 5, the treatment unit 140 and suction unit 100 may be contained within a treatment unit housing 141. It will be appreciated that the filter 144 may be any device capable of filtering contaminants from the gas. For example, the filter 144 may be, including, but not limited to, a HEPA, ULPA, laser induced graphene, or MERV 9-16 filter. In some embodiments, the filter 144 may include a number of filters. As exemplified in FIGS. 1-10, the filter 144 includes a pre-filter 146 and the HEPA filter 144.

The ionizer 142 may be any device capable of emitting ions. As exemplified, the ionizer 142 is a non-ozone generating bipolar ionizer. The ionizer 142 operates to emit ions that interact with airborne contaminants, providing the contaminants with a charge. An opposite charge may be applied to the filter 144 such that the charged contaminants are attracted to the filter 144, improving the removal efficiency of the filter 144. The ionizer 142 may also operate to enhance coagulation of the charged contaminants. Coagulating the contaminants decreases the number of contaminants and increases the average contaminate size, thereby allowing the contaminants to more efficiently be carried by the interior gas flow 62 and improving the removal efficiency of the filter 144. In some embodiments, the ionizer 142 may not be included. For example, the treatment unit 140 may only have a filter 144.

In some embodiments, the treatment unit 140 may include disinfecting light, such as an ultraviolet light. The ultraviolet light may be used to denature viral contaminants.

As exemplified in FIGS. 7A-7C, the gas source 20 is supplied by gas 22 removed through the inlet 80 by the suction unit 100. Accordingly, the suction unit 100 recirculates the gas 22 from the microenvironment 12 and provides the pressure force for delivering and expelling the gas 22 from the first outlet 40 and the second outlet 60. Thus, once gas 22 is removed from the microenvironment 12, it is treated by the treatment unit 140 before being recirculated to the first and second outlets 40, 60 to form the gas curtain 42 and the interior gas flow 62, respectively. In other words, as exemplified, the gas source 20 is the recirculated, decontaminated gas 22 from the microenvironment 12 that is delivered by the suction unit 100.

In some embodiments, as exemplified in FIG. 3, the system 10 may include one or more dampers 180. The dampers 180 may be used to control the flow of gas 22 from the gas source 20 to the first outlet 40 and the second outlet 60. In some embodiments, the damper 180 may be used to vary the static pressure at the entry point of the conduits supplying gas 22 to the first outlet 40 and the second outlet 60, thereby varying the volume of gas supplied to the gas curtain 42 and/or interior gas flow 62. Varying the volume of gas 22 supplied to the gas curtain 42 and/or interior gas flow 62 may be used to control the velocity of the expelled gas 22. Those skilled in the art will appreciate that the dampers may be replaced with alternative devices for controlling gas flow within the system 10, including, but not limited to, iris dampers, airflow valves, venturi valves, gate dampers, restrictors, and/or reducers.

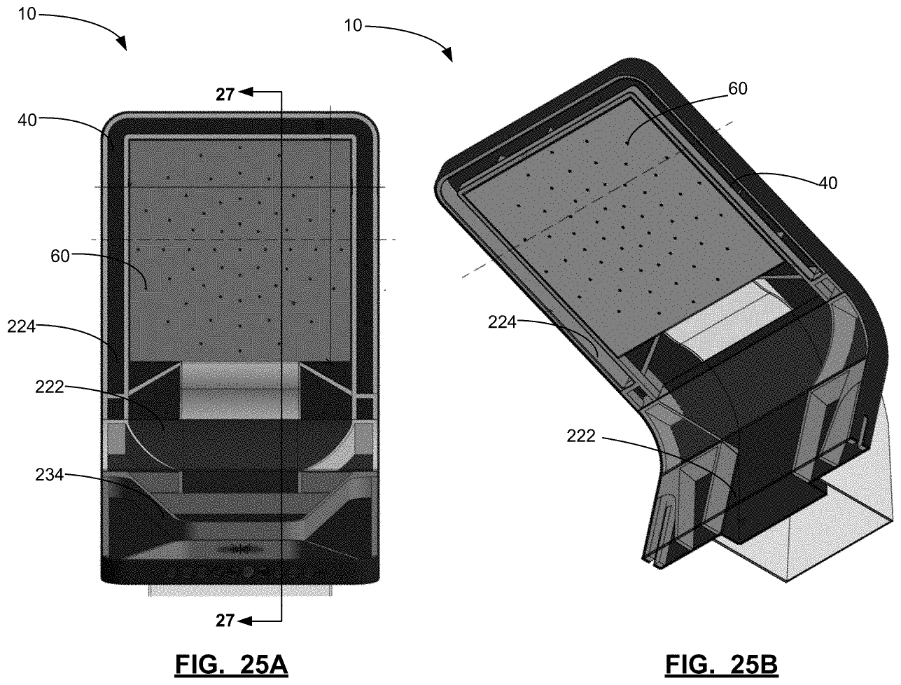

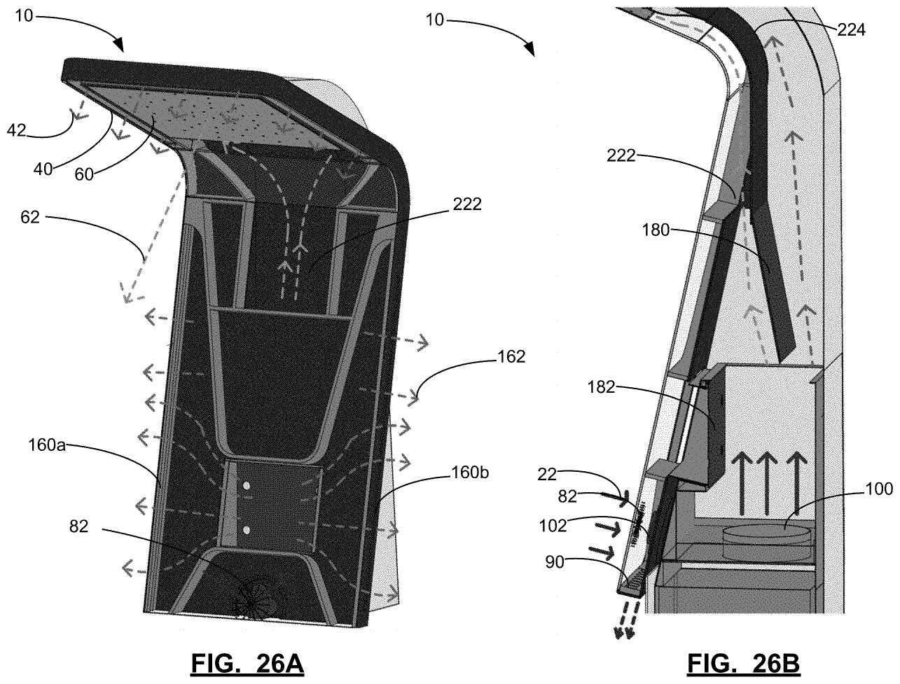

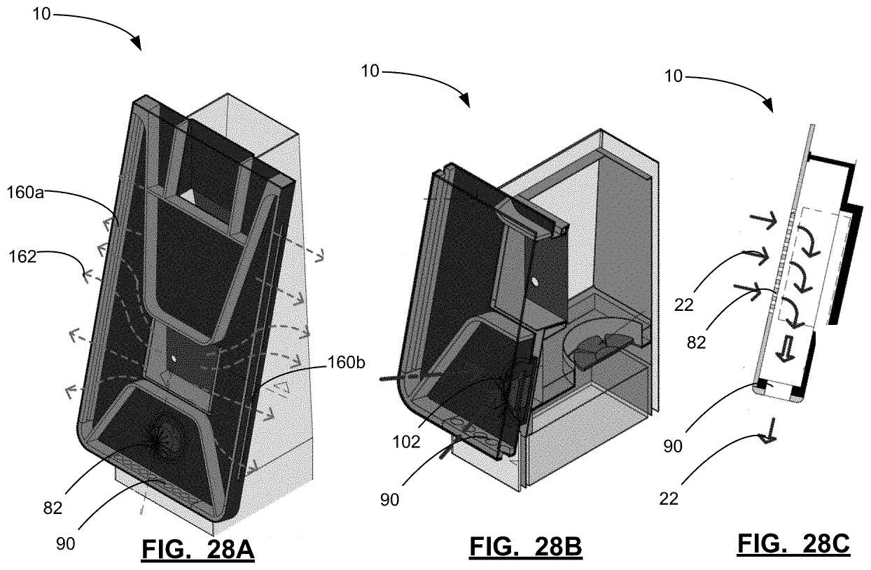

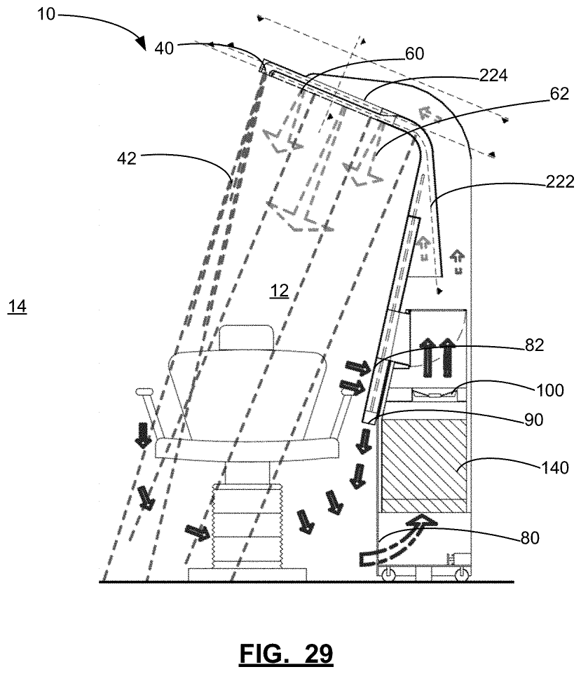

When the gas source 20 is supplied by the recirculated gas 22 from the microenvironment 12, the volume of gas 22 within the microenvironment 12 may be completely recycled at a rate dependent on the size of the microenvironment 12. As exemplified in FIGS. 7A-7C, the microenvironment 12 has a volume 13 of gas 22. In other words, the rate of exchange of the volume 13 will vary depending on the size of the volume 13. The inventors have found that the exemplary embodiment can make may more gas changes per hour than prior art systems. For example, prior art research laboratories typically operate at 10-12 gas changes per hour, pharmaceutical manufacturing spaces typically operate at 20 gas changers per hour, and cleanrooms suitable for sterile vaccine filling typically operate at 240-360 air changes per hour. For example, in the exemplified embodiment of FIGS. 1-11 and 23-29, the volume 13 may be exchanged at a rate of about 450 gas changes per hour.

It will be appreciated that the volume 13 may be exchanged at a rate of at least 20 gas changes per hour. In other exemplary embodiments, the volume 13 may be exchanged at a rate of about 20 to about 1000 gas changes per hour.

It will be appreciated that, the gas source 20 may be a separate gas source that is not recirculated from the microenvironment 12, such as for example, a blower that delivers outdoor air. Alternatively, the gas source 20 may be a combination of several gas supplies, such as recirculated gas 22 from the microenvironment 12 described above, the ambient environment 14, and/or an external environment. The gas supply from the ambient or external environment may be delivered by separate blowers (not shown) which deliver air to the first and second outlets through any suitable conduits (also not shown). In such alternative embodiments, gas 22 that is removed from the microenvironment 12 through the inlet 80 may be exhausted to an external environment and the gas source 20 for the first outlet 40 and the second outlet 60 may be supplied from the ambient environment 14 and/or the external environment. Alternately or in addition, the gas source 20 may include treated gas 22 that has been decontaminated and recirculated from the microenvironment 12 as well as fresh gas from the external environment. It will be appreciated that the system 10 may be in fluid communication with the existing HVAC system. In some embodiments, each of the first outlet 40 and the second outlet 60 may have their own separate gas source. In some embodiments, one or more blowers may be included upstream of the first outlet 40 and the second outlet 60 to vary the first velocity and the second velocity.

### Purge Outlet

In accordance with this aspect, which may be used by itself or in combination with one or more other aspects, the system 10 may be provided in an enclosed space and may include a fourth outlet. The fourth outlet may be used to expel gas 22 supplied by the gas source 20 to facilitate circulation of the gas 22 throughout the enclosed space. For example, after the gas curtain 42 and interior gas flow 62 have been turned off, the fourth outlet may be used to purge residual contaminants in the enclosed space by circulating the gas 22 in the enclosed space and returning the gas 22 through the inlet 80 by way of the suction unit 100. An advantage of this design is that once the user has finished with the gas curtain 42 and interior gas flow 62, the user may leave the enclosed space and the fourth outlet may be used to remove residual contaminants from the ambient environment 14 within the enclosed space.

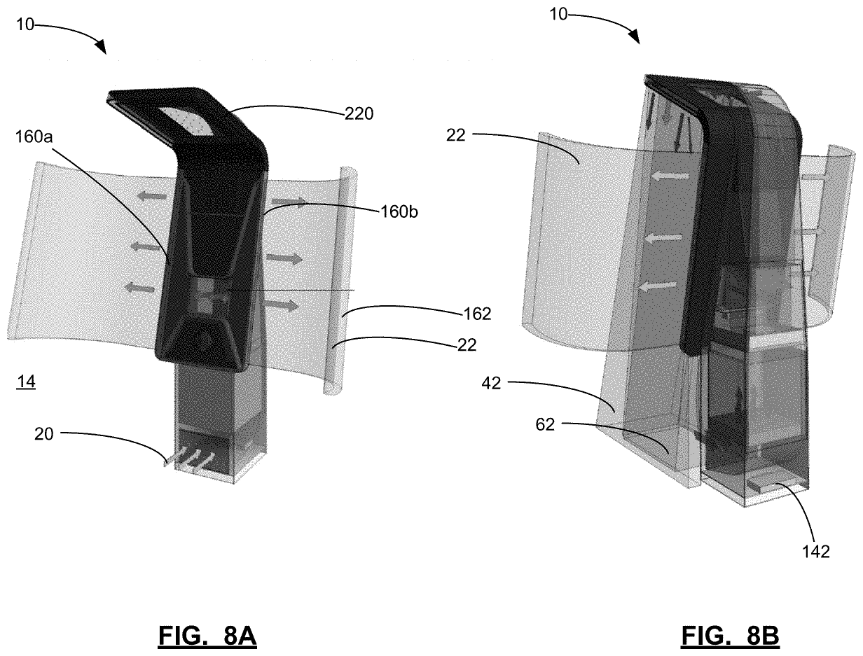

In accordance with this aspect, as exemplified in FIGS. 1-10, the system 10 includes two fourth outlets 160a, 160b. As shown in FIGS. 8A and 8B, the fourth outlets 160a, 160b are each configured for expelling gas 22 from the gas source 20. As exemplified, the system 10 includes a second damper 182. The second damper 182 may be used to divert gas 22 expelled by the suction unit 100 to the fourth outlets 160a, 160b instead of to the first outlet 40 and the second outlet 60. In operation, after the gas curtain 42 and interior gas flow 62 are turned off by moving the second damper 182, the fourth outlets 160a, 160b expel a purge gas flow 162 that is used to assist with purging the enclosed space of residual contaminants. In other words, the purge gas flow 162 may facilitate circulation of gas 22 in the enclosed space such that a volume of gas 22 in the ambient environment 14 may be fully recirculated through the treatment unit 140 at a faster rate than if the fourth outlets 160a, 160b had not been used. The purge gas flow 162 may make use of the Coanda effect as described above. In other words, the purge gas flow 162 may be expelled proximate the walls and/or floor of the enclosed space to remove contaminants more efficiently from the enclosed space.

It will be appreciated that the size, shape, and number of third outlets may vary depending on the enclosed space. In some embodiments, the system 10 may include a third damper for adjusting the flow between the fourth outlet 160a and the fourth outlet 160b. In some embodiments, there may be a single fourth outlet. Alternately or in addition, an existing HVAC inlet may also be used in combination with the inlet 80 to more rapidly remove contaminants from the enclosed space.

Accordingly, the system 10 may be used to reduce the fallow time between successive occupiers of the space. For example, when the system 10 has been used by a health worker to work on a patient and the occupants have left the ambient environment 14, the system 10 may be used to purge contaminants from the ambient environment 14 at a more rapid rate. Thus, the time delay between the occupants leaving and new occupants being able to safely enter the ambient environment 14 may be reduced.

### Controlling the System

In accordance with this aspect, which may be used by itself or in combination with one or more other aspects, the system 10 may include a controller (not shown) for controlling the operation of the components of the system 10. The controller may be in communication with a display in the system 10 or may be in communication with a computational device. For example, the controller may be used to control the suction unit 100, the second suction unit 102, the treatment unit 140, the damper 180, the damper 182, and the mode of the system 10 (e.g., switching between the gas curtain 42 and the purge operation).

### Exemplary Embodiment of a Medical or Dental Apparatus

An exemplary embodiment of the system 10 will now be discussed with reference to a medical or dental apparatus 200. The physician apparatus 200 is a discrete apparatus that includes the components of system 10 described herein. It will be appreciated that, in some embodiments, the physician apparatus 200 may be built into and/or in fluid communication with an existing HVAC system.

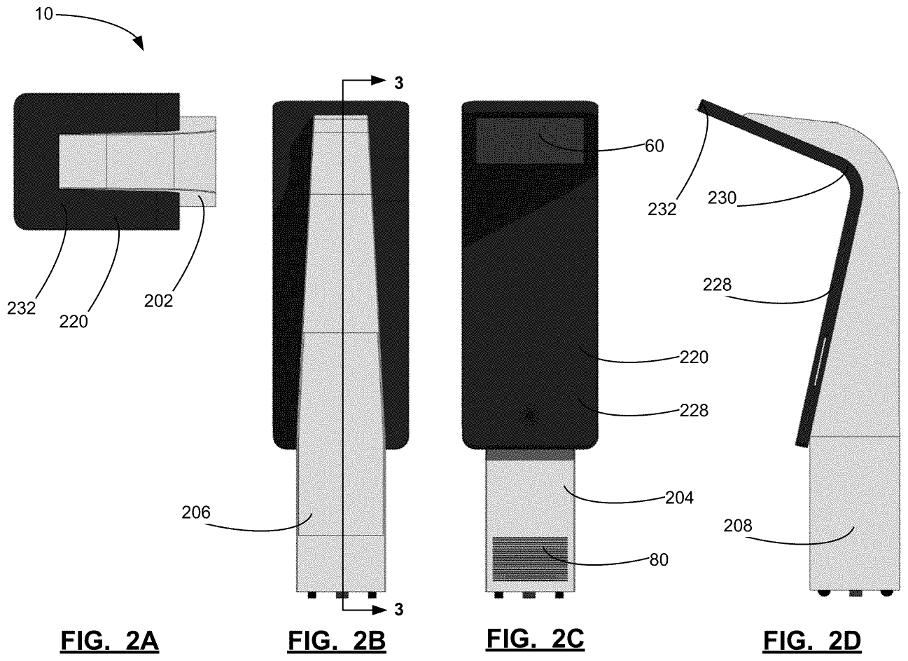

Referring to FIGS. 1-2D, the apparatus 200 has a housing 202. The housing 202 is made of a front panel 204, a rear panel 206, a first side panel 208, a second side panel 210, and a bottom panel 212. The apparatus 200 includes a hood 220. The first side panel 208 and second side panel 210 extend between the front panel 204 and the rear panel 206. Accordingly, an enclosed volume 214 capable of receiving and facilitating gas flow is formed between the front panel 204, the rear panel 206, the first side panel 208, the second side panel 210, the bottom panel 212, and the hood 220. In some embodiments, the bottom panel 212 may not be included, and the bottom edges of the front panel 204, rear panel 206, first side panel 208, and second side panel 210 may have a seal to seal the volume 214.

As exemplified in FIG. 3, the hood 220 includes a first plenum 222 in fluid communication with the first outlet 40 and a second plenum 224 in fluid communication with the second outlet 60. The first outlet 40 and the second outlet 60 are positioned in the hood 220. The first plenum 222 and the second plenum 224 provide fluid communication from the volume 214 to the first outlet 40 and the second outlet 60 respectively. The hood 220 also includes a third plenum 226 that provides fluid communication between the fourth outlet 160 and the volume 214.

As exemplified in FIG. 6, the hood 220 may be made of a lower plenum panel 228, a plenum connector 230, and an upper plenum panel 232. The plenum connector 230 forms a gas flow conduit with the upper plenum panel 232 and the lower plenum panel 228. The first plenum 222 and the second plenum 224 extend from the lower plenum panel 228, through the plenum connector 230, and into the upper plenum panel 232, thereby forming a gas flow conduit connecting the first outlet 40 and the second outlet 60 to the suction unit 100. The third plenum 226 is located in the lower plenum panel 228.

As exemplified, the lower plenum panel 228 includes a ribbed frame 234 for separating the third plenum 226 from the first plenum 222. The ribbed frame 234 is covered by a front hood panel 236, which includes the auxiliary inlet 82 and the third outlet 90. When the apparatus 200 includes a display, the display may be positioned on the front hood panel 236. The upper plenum panel 232 includes a top hood panel 238 that covers the second plenum 224 and a portion of the first plenum 222.

As exemplified, the first outlet 40 is formed of the first slot 44, second slot 46, and third slot 48 in the upper plenum panel 232. Accordingly, the microenvironment 12 is created by the three planes in the gas curtain 42, the front panel 204, and a portion of the hood 220 (acting as the physical wall 120 described previously). As exemplified, the second outlet 60 is formed of the plurality of openings 64 in an interior gas flow plate 240 positioned below the upper plenum panel 232 and in fluid communication with the upper plenum panel 232. An interior gas flow trim 242 may be used to secure the interior gas flow plate 240 to the upper plenum panel 232. In some embodiments, the hood 220 includes hood trim 244 that connects the lower plenum panel 228, the plenum connector 230, and the upper plenum panel 232.

The apparatus 200 includes the inlet 80 located in the front panel 204. The inlet 80 is connected to the suction unit 100 through the volume 214 such that gas 22 may pass from the inlet 80 to the suction unit 100. As exemplified, the suction unit 100 is a fan. The apparatus 200 also includes the auxiliary inlet 82 in communication with the second suction unit 102, which operates to move gas more rapidly 22 towards the inlet 80.

The apparatus 200 also includes the first damper 180 and the second damper 182. The first damper 180 is in fluid communication with the suction unit 100. As described previously, the first damper 180 and the suction unit 100 may be used to control the flow rates of the gas curtain 42 and the interior gas flow 62. In some embodiments, the flow rates may be supplemented by one or more blowers.

The second damper 182 may be used during the purge mode described previously. The second damper 182 may be controlled to divert the gas 22 expelled by the suction unit 100 from the first outlet 40 and the second outlet 60 to the fourth outlets 160a, 106b. In other words, the second damper 182 may be used to turn off the gas curtain 42 and the interior gas flow 62, thereby diverting gas 22 to the fourth outlets 160a, 160b.

The apparatus 200 includes the treatment unit 140. As exemplified, the treatment unit 140 includes the ionizer 142, the filter 144, and the pre-filter 146. As shown in FIG. 3, the ionizer 142 is positioned proximate the inlet 80. The pre-filter 146 is positioned above the ionizer 142 and the filter 144 is positioned above the pre-filter 146. The ionizer 142, pre-filter 146, and filter 144 are positioned below the suction unit 100. Accordingly, the suction unit 100 is configured to draw gas 22 through the inlet 80, past the ionizer 142, through the pre-filter 146, and through the filter 144. This process treats the gas 22 before it is expelled from the first outlet 40 and the second outlet 60. The rear panel 206 is removable to access the treatment unit 140, electronic control panels, and/or suction unit 100 for replacement and/or repair.

In some embodiments, the apparatus 200 may be movable. As exemplified, the apparatus 200 includes wheels 250 and a stabilizer 252. The wheels 250 allow the apparatus 200 to be moved throughout the ambient environment 14, as exemplified in FIGS. 9A-11. The stabilizer 252 provides stability for the apparatus 200 when the apparatus 200 has been moved to the proper position. For example, the stabilizer 252 may be used as a brake to prevent lateral movement of the apparatus 200.

To begin the operation of the exemplary apparatus 200, the suction unit 100 is turned on. The suction unit 100 provides a suction force to the inlet 80 and the second suction unit 102 provides a suction force to the inlet 82, resulting in the removal of gas 22 from the microenvironment 12. The gas 22 removed through the auxiliary inlet 82 is expelled through the third outlet 90 towards the inlet 80, where the gas 22 is subsequently removed through the inlet 80. The gas 22 removed through the inlet 80 then passes the ionizer 142, through the pre filter 146, through the filter 144, and through the suction unit 100. The suction unit 100 provides a blowing force to the gas 22, expelling it upwards through the volume 214 and towards the first outlet 40 and the second outlet 60. The damper 180 is used to control the direction and velocity of the gas 22 before reaching the first outlet 40. Gas 22 also passes the damper 180 and proceeds towards the second outlet 60. As described previously, in some embodiments, one or more auxiliary blowers may be used to further control the velocity of the gas 22 as it is expelled from the first outlet 40 and the second outlet 60. Gas 22 passes through the first plenum 222 and through the second plenum 224 to reach the first outlet 40 and the second outlet 60 respectively. The gas 22 is then expelled downward from the first outlet 40 and the second outlet 60 to form the gas curtain 42 and the interior gas flow 62. The gas curtain 42 separates the microenvironment 12 from the ambient environment 14, while the interior gas flow 62 moves gas 22 downward within the microenvironment 12 towards the inlet 80. The gas 22 is then repeatedly recirculated in the same manner as discussed above.

Once the operation has completed and the occupants have left the ambient environment 14, the apparatus 200 may be used to purge the ambient environment 14. The operation is the same as described above, except that the gas 22 is expelled from the fourth outlets 160a, 160b to form the purge gas flow 162. The purge gas flow 162 facilities the movement of gas throughout the ambient environment 14. The suction unit 100 continues to provide a suction force for removing gas from the ambient environment 14 through the inlet 80. As described previously, the Coanda effect may assist with the removal of contaminants from the ambient environment 14.

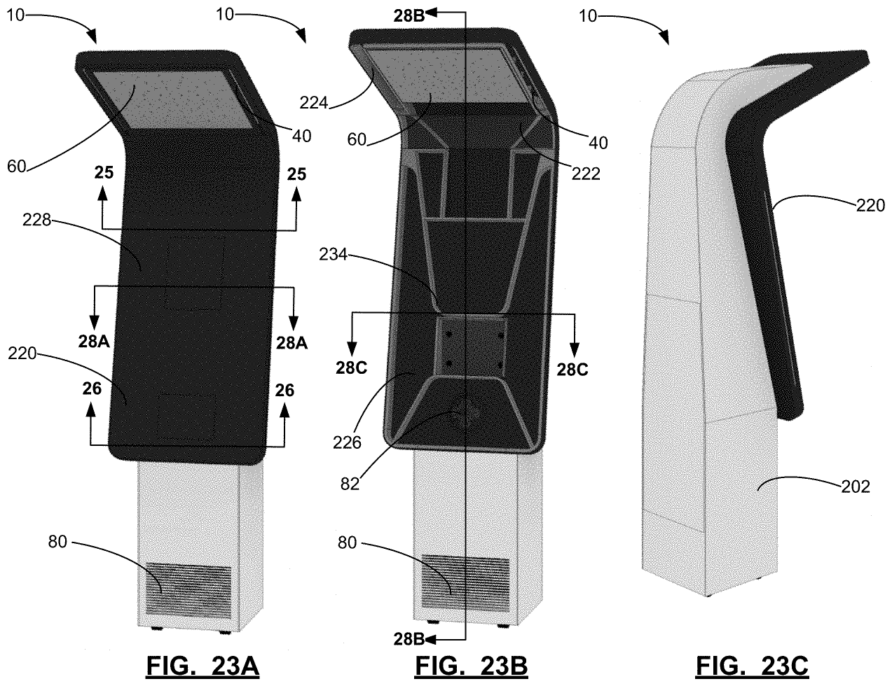

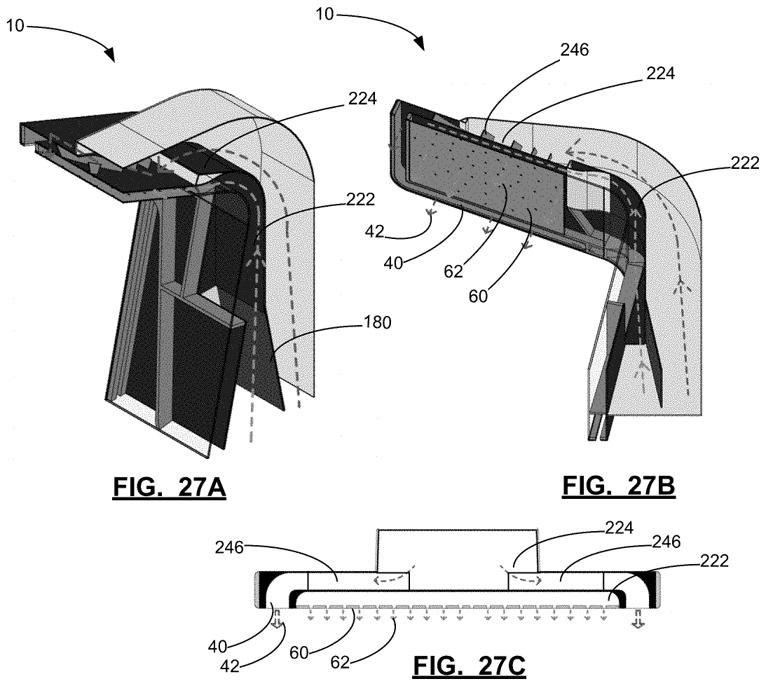

In some embodiments, the gas flow configuration of the first plenum 222 and the second plenum 224 may be reversed such that the first plenum 222 is in fluid communication with the second outlet 60 and the second plenum 224 is in fluid communication with the first outlet 40, as exemplified in FIGS. 23-29. For example, referring to FIGS. 27A and 27B, the first plenum 222 provides a flow path for gas 22 to pass from the suction unit 100 to the second outlet 60, thereby forming the interior gas flow 62 when the gas 22 is expelled through the second outlet 60. The second plenum 224 provides a flow path for gas 22 to pass from the suction unit 100 to the first outlet 40, thereby forming the gas curtain 42 when the gas 22 is expelled from the first outlet 40.

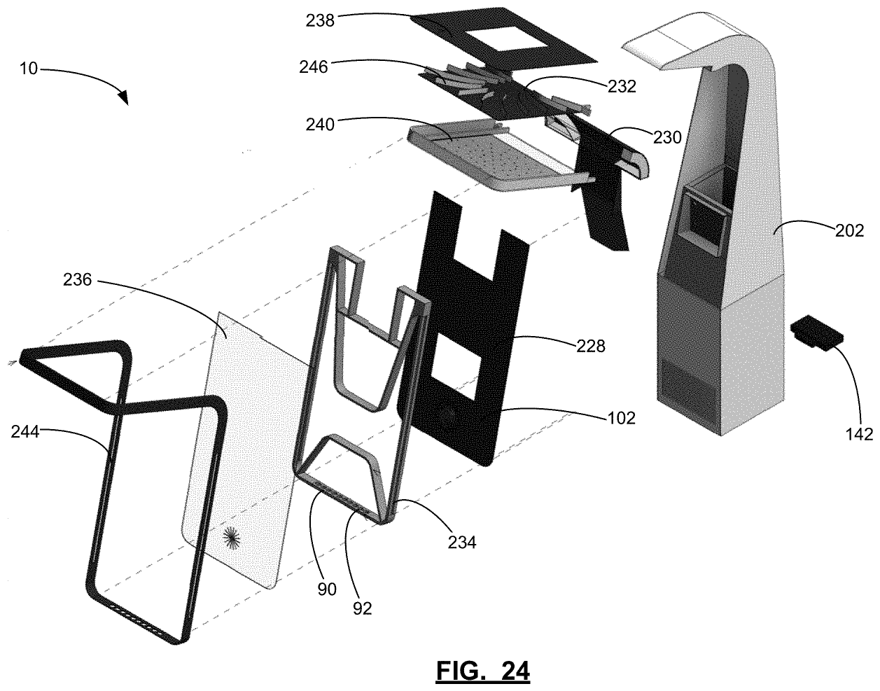

In some embodiments, as exemplified in FIGS. 24, 27B, and 27C, the second plenum 224 may include at least one baffle 246. The baffle 246 may be used to improve the distribution of gas 22 in the second plenum 224, thereby improving the consistency of the gas curtain 42. As shown, there is a plurality of baffles 246. The baffles 246 provide directionality to the gas 22 as it reaches the plenum 224, helping to spread the gas 22 to all areas of the plenum 224.

In some embodiments, the purge gas flow 162 may also be used in combination with an existing HVAC system, as described previously, to more rapidly purge contaminants from the ambient environment 14. Accordingly, the fallow time, or the time between patients, may be reduced.

### Experimental Results

The following is a description of data generated by using the apparatus 200 in a simulated dental environment. The flow models were assumed to be under steady-state conditions with turbulence modelled using the RANS k-w SST closure model. Local mesh refinement was applied to various areas of interest. Simplified representations of a dental chair, furniture, dentist, assistant and patient were used. The locations for the supply and return diffusers were set to typical conditions in a small space of this form. Generic thermal loads for the occupants, lights and devices were implemented.

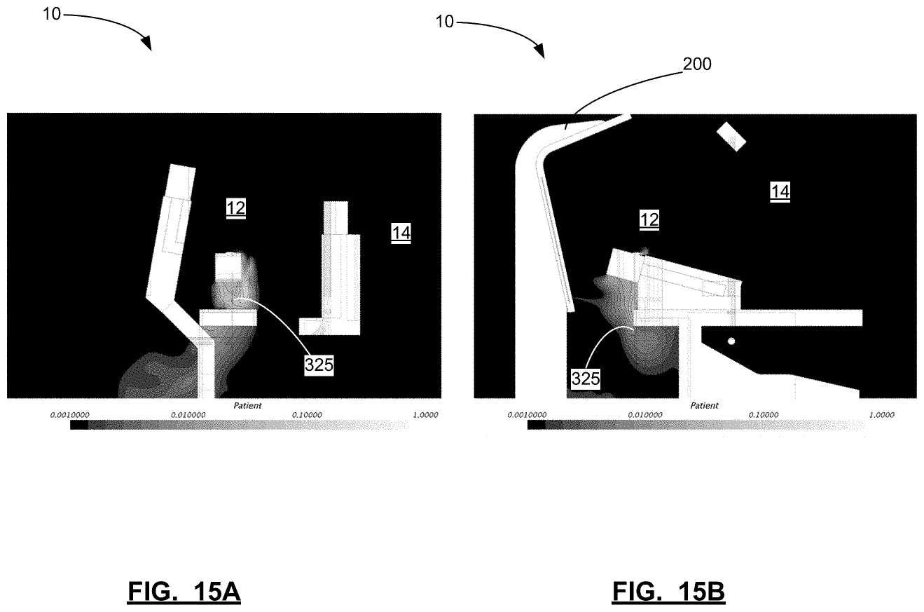

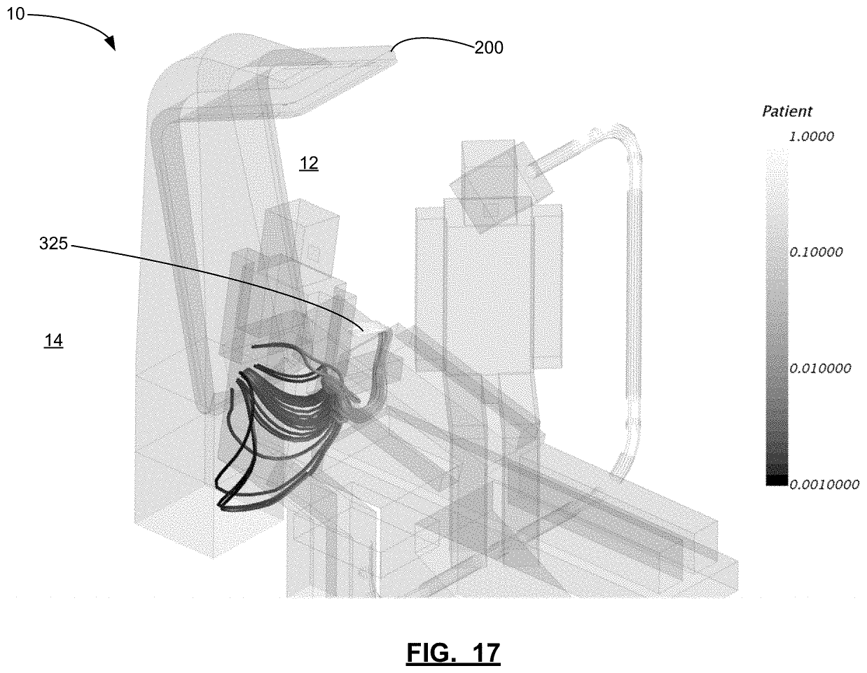

As exemplified in FIGS. 9A-21, the system 10 is positioned in an enclosed space 300. The enclosed space 300 includes the ambient environment 14 and the microenvironment 12. As exemplified, the space 300 has a length 305 of 3.5 m, a width 306 of 3.5 m, and a height 307 of 2.8 m. It will be appreciated that the size of the space 300 will vary depending on the use of the system 10. The space 300 has an HVAC system with an HVAC outlet 310 and an HVAC inlet 312. The HVAC supply of gas expelled from the outlet 310 has a rate of 1.4 m/s. the HVAC system was set to provide 9 gas changes per hour for the enclosed space 300. The space 300 includes a door 302 with an opening 304 at the bottom of the door 302.

As shown, the room 300 includes a dentist 320, an assistant 322, and a patient 324. During the experiment, the dentist exhales gas 321, the assistant exhales gas 323, and the patient exhales gas 325. The exhalation rate of the dentist 320 and assistant 322 is 0.06 m/s, while the exhalation rate of the patient is 0.054 m/s. A passive scalar (e.g., cloud of massless particles) was released from the mouth of each of the three occupants in order to track the transport of aerosols and/or droplet nuclei. Exhalation rates from the occupants were equivalent to light activity for the dentist and assistant, and rest for the patient.

The experiment was run with the inlet 80 as the sole inlet into the volume 214 of the apparatus 200. The thickness of the first outlet 40 is 32 mm and the first velocity is 2.0 m/s at the first outlet 40, resulting in a first velocity of 1.0 m/s at the patient. The second velocity of the interior gas flow 62 is 0.457 m/s.

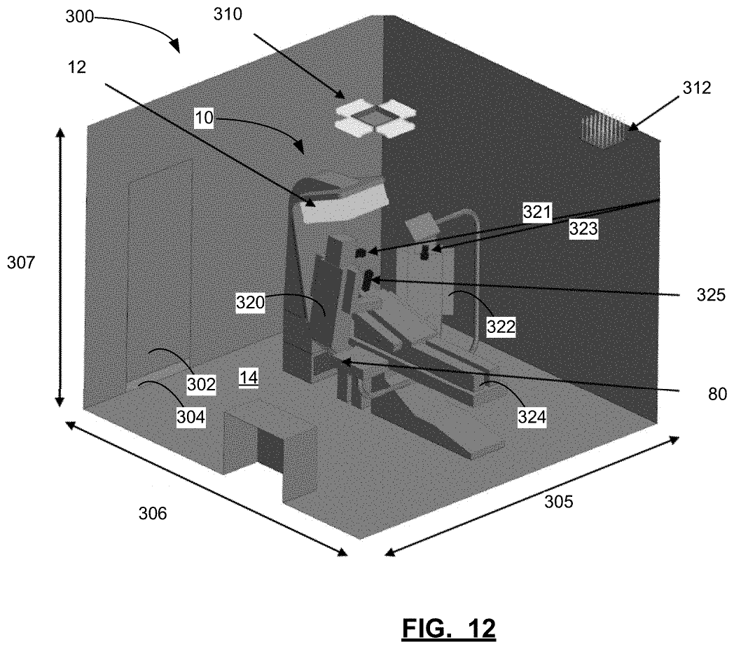

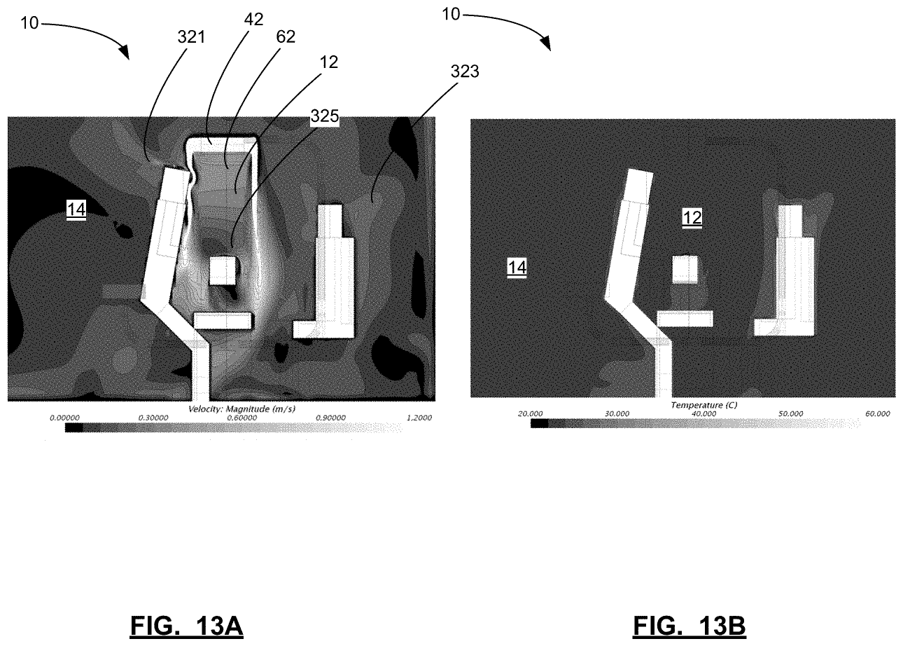

Referring now to FIG. 13A, a computation fluid dynamic (CFD) diagram is provided, illustrating the velocity of gas flows within the system 10. As shown, the dentist 320 (shown in FIG. 12) has positioned her arm through the gas curtain 42 to operate on the patient 324 (shown in FIG. 12). The gas curtain 42 is interrupted but continues to substantially separate the microenvironment 12 from the ambient environment 14. Furthermore, the exhaled gases 321 and 323 from the dentist 320 and assistant 322 (shown in FIG. 12), respectively, are maintained in the ambient environment 14 and do not pass into the microenvironment 12 unless they are removed through the inlet 80. Similarly, the exhaled gas 325 of the patient 324 remains in the microenvironment 12 and is substantially prevented from entering the ambient environment 14.

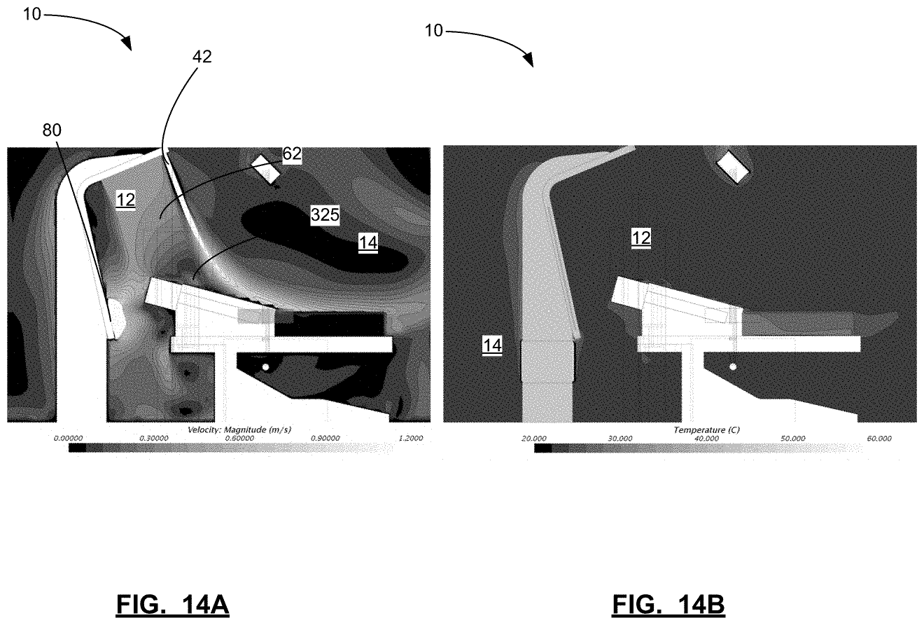

Referring now to FIG. 14A, 15A, 15B, and 17, CFD diagrams are provided illustrating the gas 325 exhaled by the patient 324. As shown, the gas 325 is substantially maintained within the microenvironment 12 before being removed through the inlet 80.

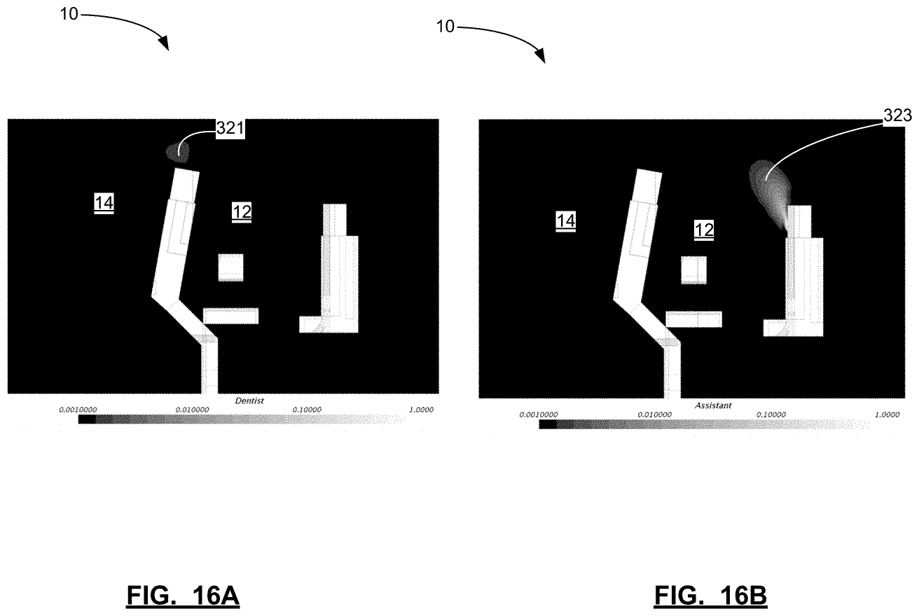

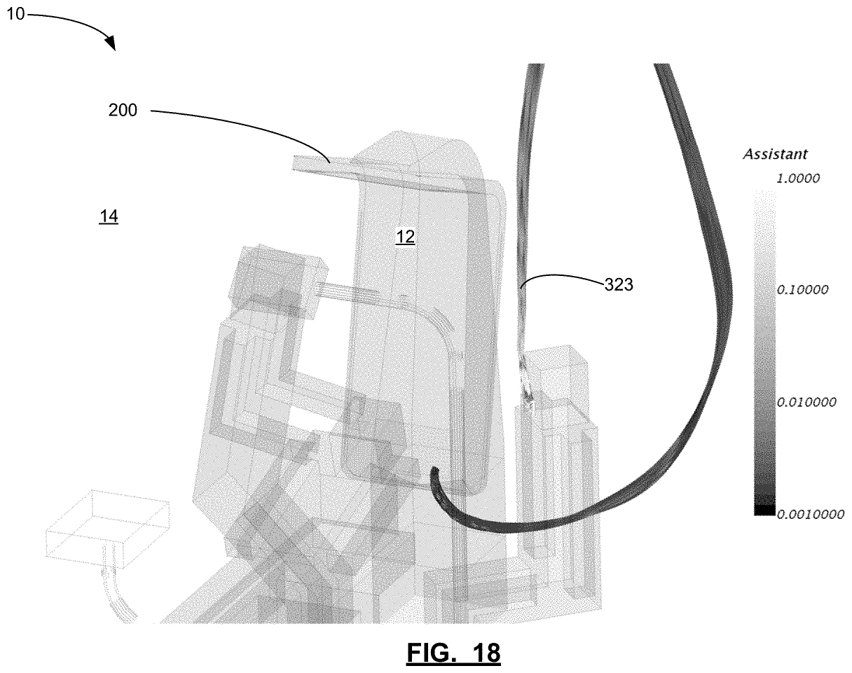

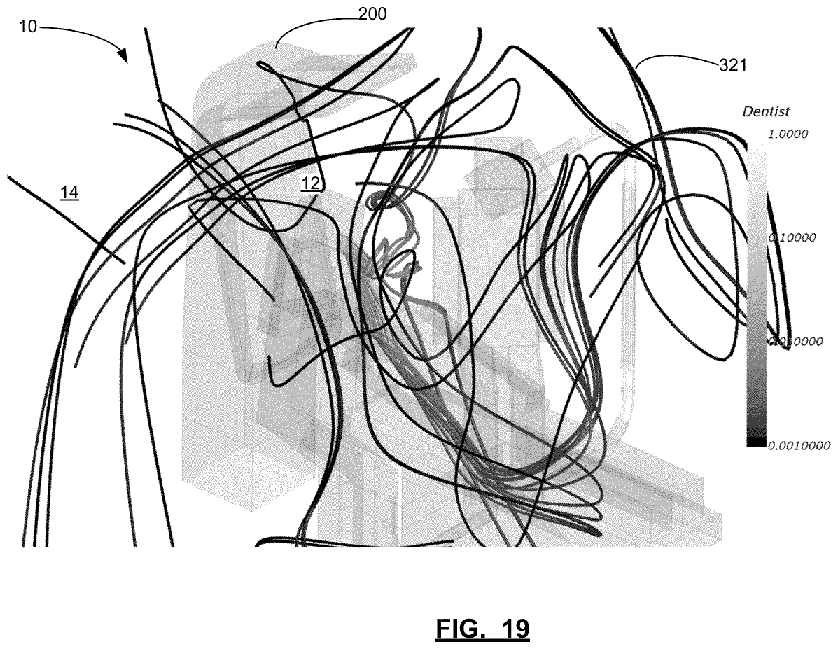

Referring now to FIGS. 16A and 19, CFD diagrams are provided illustrating the gas 321 exhaled by the doctor 320. As shown, the exhaled gas remains in the ambient environment 14 and does not enter the microenvironment 12 until the gas is removed through the inlet 80. Similarly, referring to FIGS. 16B and 18, CFD diagrams are provided illustrating the gas 323 exhaled by the assistant 322. As shown, the exhaled gas remains in the ambient environment 14 and does not enter the microenvironment 12 unless the gas is removed through the inlet 80.

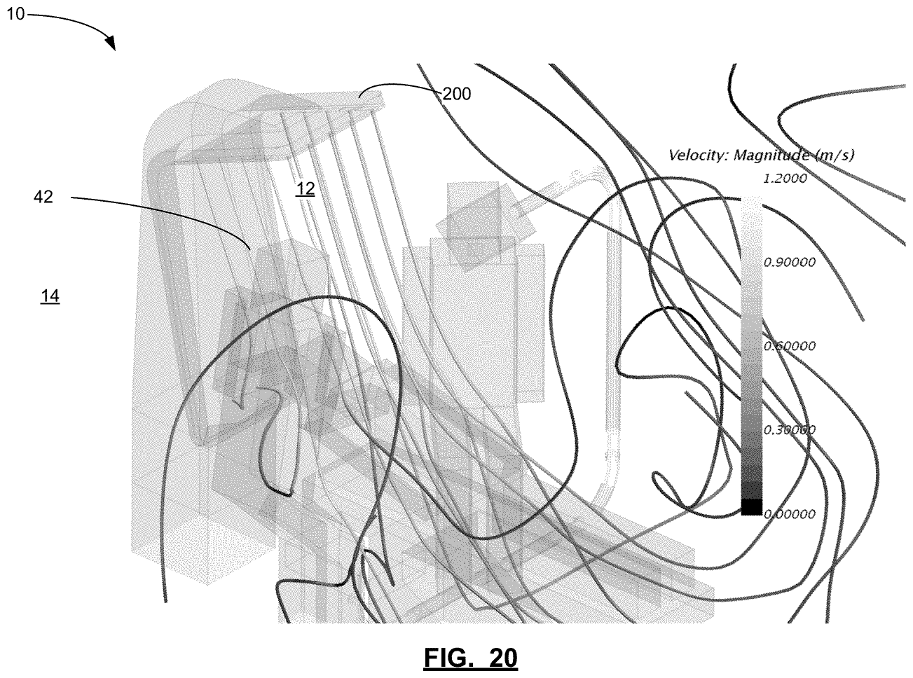

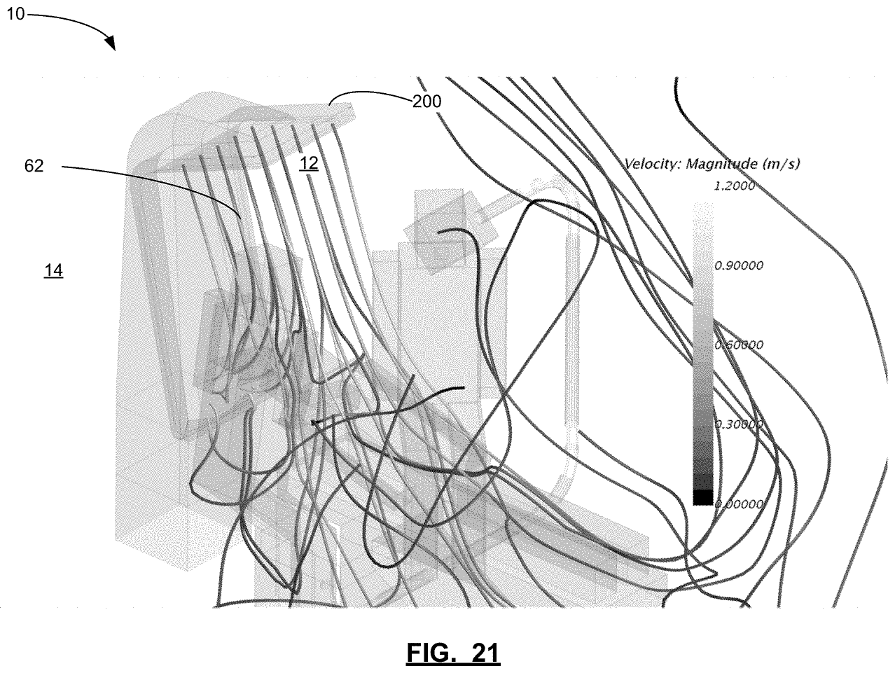

Referring now to FIG. 20, shown therein is a CFD diagram illustrating the flow of the gas curtain 42. As shown, most of the gas curtain 42 is removed from the microenvironment 12 through the inlet 80. The dentist 320 has penetrated the gas curtain 42, releasing some of the gas 22 into the ambient environment 14. This released gas 22 may then be returned by way of the inlet 80. Similarly, referring to FIG. 21, shown therein is a CFD diagram illustrating the flow of the interior gas flow 62. As shown, some of the gas 22 is released into the ambient environment 14 by the penetration of the arm of the dentist 320 through the gas curtain 42.

It will be appreciated that the computational fluid dynamic diagrams of FIGS. 13-21 are approximated and will vary with the movement of the dentist 320 and the assistant 322. The CFD diagrams will also vary with varying flow rates of the gas curtain 42, the interior gas flow 62, and the position of the inlet 80 and/or auxiliary inlet 82.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A system for using a gas to create a microenvironment within an ambient environment, the system comprising:
a first outlet configured for expelling a gas at a first velocity sufficient for producing a gas curtain, wherein the gas curtain separates the microenvironment from the ambient environment;
a second outlet configured for expelling the gas at a second velocity within the microenvironment, wherein the first velocity is greater than the second velocity;
an inlet spaced apart from the first outlet and the second outlet;
a suction unit in fluid communication with the inlet and the first and second outlets, the suction unit located downstream of the inlet and upstream of the first and second outlets, wherein the suction unit is configured for removing the gas from the microenvironment through the inlet and supplying at least a portion of the gas expelled from the first and second outlets.

2. The system of claim 1, wherein the suction unit is configured to supply all of the gas expelled by the first and second outlets.

3. The system of claim 1, further comprising a gas source configured to deliver a remaining portion of the gas expelled by the first and second outlets from an external environment.

4. The system of claim 1, wherein the inlet is located below the first outlet and the second outlet.

5. The system of claim 1, further comprising a treatment unit upstream of the first and second outlets.

6. The system of claim 1, wherein the treatment unit comprises at least one of an ionizer and an air filter.

7. The system of claim 1, wherein the suction unit is configured to recirculate the gas removed through the inlet to the first and second outlets.

8. The system of claim 1, wherein the system is configured such that the direction of the gas entering the inlet is substantially perpendicular to the direction of the gas expelled by the first outlet and the second outlet.

9. The system of claim 1, wherein the inlet comprises a first inlet and a second inlet, the second inlet being positioned between the first inlet and the first outlet, wherein the gas in the microenvironment is removed through the second inlet.

10. The system of claim 9, further comprising a third outlet in fluid communication with the second inlet, wherein the gas removed through the second inlet is expelled through the third outlet towards the first inlet.

11. The system of claim 1, wherein the first outlet is a slot that has a thickness, wherein the thickness is in the range of about 12 mm to about 100 mm.

12. The system of claim 1, further comprising a blower for increasing at least one of the first velocity and the second velocity.

13. The system of claim 1, wherein the first outlet surrounds at least three sides of the second outlet.

14. The system of claim 1, wherein the first velocity is in the range of about 1 m/s to about h3 m/s.

15. The system of claim 1, wherein the second velocity is in the range of about 0.3 m/s to about 1 m/s.

16. The system of claim 1, wherein the microenvironment defines a volume of gas and the system is configured to exchange the volume of gas at a rate of at least about 20 gas changes per hour.

17. A system for using a gas to create a microenvironment within an ambient environment, the system comprising:
a gas source;
a first outlet located downstream of the gas source and in fluid communication with the gas source, wherein the gas is expelled from the first outlet at a first velocity sufficient for producing a gas curtain, wherein the gas curtain separates the microenvironment from the ambient environment;
a second outlet located downstream of the gas source and in fluid communication with the gas source, wherein the gas is expelled from the second outlet into the microenvironment at a second velocity, wherein the first velocity is greater than the second velocity;
an inlet spaced apart from the first outlet and the second outlet;
a suction unit in fluid communication with the inlet, the suction unit located downstream of the inlet, wherein the suction unit is configured for removing the gas from the microenvironment through the inlet.

18. A method of using a gas to create a microenvironment within an ambient environment, the method comprising:
providing a gas curtain, wherein the gas curtain is provided by the gas expelled from a first outlet at a first velocity, wherein the gas curtain separates the microenvironment from the ambient environment;
providing an interior gas flow within the microenvironment, wherein the interior gas flow is provided by the gas expelled from a second outlet into the microenvironment at a second velocity, wherein the first velocity is greater than the second velocity; and
removing the gas from the microenvironment through an inlet in fluid communication with a suction unit, wherein the suction unit is configured to supply at least a portion of the gas expelled from the first and second outlets.19
